(19) United States
(12) Patent Application Publication
(10) Pub. No.: US 2026/0018835 A1
(43) Pub. Date: Jan. 15, 2026

(54) SLIM HIGH-SPEED HIGH-DENSITY ELECTRICAL CONNECTOR

(71) Applicant: Amphenol Commercial Products (Chengdu) Co., Ltd., Chengdu (CN)

(72) Inventors: Jun Fan, Chengdu (CN); Tao Zeng, Chengdu (CN); Yaohua Hou, Chengdu (CN)

(73) Assignee: Amphenol Commercial Products (Chengdu) Co., Ltd., Chengdu (CN)

(21) Appl. No.: 19/262,843

(22) Filed: Jul. 8, 2025

(30) Foreign Application Priority Data
Jul. 10, 2024 (CN) 202410932491.7
Jul. 10, 2024 (CN) 202421644658.1

(51) Int. Cl. H01R 13/6585; H01R 12/73

(52) U.S. Cl. CPC H01R 13/6585; H01R 12/737

(57) ABSTRACT

Slim high-speed high-density electrical connectors. A connector includes a housing with a slot between side walls, and a terminal assembly disposed between the side walls. A side wall includes first and second grooves alternatively disposed. The terminal assembly includes terminals held by an assembly housing. The terminals include terminal pairs and signal terminals extending in the first and second grooves, respectively. Inner and outer shields are attached to opposite sides of the assembly housing and protrude into the assembly housing to contact the single terminals. The outer shield includes extensions at least partially overlapping the mating ends and contact tails of the terminal pairs, respectively. The inner shield is configured to provide inner shielding together with a ground layer of a card inserted in the slot. Such a configuration can satisfy the industry's high-speed and the high-density requirements, including those defined by standards such as PCIe Gen 6.

### CROSS-REFERENCE TO RELATED APPLICATIONS

This application claims priority to and the benefit of Chinese Patent Application No. 202410932491.7, filed on Jul. 10, 2024. This application also claims priority to and the benefit of Chinese Patent Application No. 202421644658.1, filed on Jul. 10, 2024. The contents of these applications are incorporated herein by reference in their entirety.

### TECHNICAL FIELD

This application relates generally to interconnection systems, such as those including electrical connectors, used to interconnect electronic assemblies.

### BACKGROUND

Electrical connectors are used in many electronic systems. It is generally easier and more cost effective to manufacture an electronic system as separate electronic assemblies, which may be joined together with electrical connectors. Electrical connectors may be used for interconnecting assemblies so that the assemblies may operate together as part of an electronic system. Electrical connectors, for example, may be mounted onto printed circuit boards within two assemblies that are connected by mating the electrical connectors. In another electronic system, it may be impractical to join two printed circuit boards by directly mating electrical connectors on these printed circuit boards. For example, these printed circuit boards may be spaced so far apart in the electronic system that the electrical connectors mounted on the printed circuit boards cannot be directly connected.

Electronic systems have generally become smaller, faster, and more functionally complex. These changes imply that the number of circuits within a given area and operating frequencies of the circuits of an electronic system have significantly increased in recent years. Current systems transfer more data between printed circuit boards and require electrical connectors to be able to transmit signals at a higher speed than those of several years ago.

One of the challenges in manufacturing high-density, high-speed electrical connectors is that the conductors within the electrical connectors may be too dense to generate electrical interference between adjacent signal conductors. To reduce such interference and, moreover, to provide desired electrical properties, a shielding is usually placed between or around adjacent signal conductors. The shielding prevents signal carried by a conductor from generating “crosstalk” on another conductor. The shielding also affects the impedance of each conductor, which can further contribute to the desired electrical properties.

### SUMMARY

Aspects of the present disclosure relate to slim high-speed high-density electrical connectors.

Some embodiments relate to a terminal assembly. The terminal assembly may include a plurality of terminals, each of the plurality of terminals comprising a mating end, a contact tail, and an intermediate portion between the mating end and the contact tail; a housing at least partially holding the intermediate portions of the plurality of terminals such that the plurality of terminals are aligned in a row, the housing comprising a plurality of openings exposing selected terminals of the plurality of terminals; and a shield comprising portions protruding into respective openings of the plurality of openings of the housing.

Optionally, the shield spans one or more segments of the plurality of terminals aligned in the row.

Optionally, the plurality of terminals comprise a plurality of pairs of terminals, each pair disposed between adjacent terminals of the selected terminals of the plurality of terminals.

Optionally, for each segment of the one or more segments of the plurality of terminals spanned by the shield, the pairs of terminals are configured for high-speed signal transmission, and the selected terminals are configured for ground; and terminals that are outside the shield are configured for side band.

Optionally, the shield protrudes beyond the housing towards the contact tails of the plurality of terminals.

Optionally, the shield comprises a body and one or more extensions, each of the one or more extensions extending from the body towards the mating ends of a respective pair of terminals.

Optionally, the shield comprises one or more second extensions, each of the one or more second extensions extending from the body and transversely to the body greater than 65 degrees with respect to the body to overlap the contact tails of a respective pair of terminals, the contact tails of the respective pair of terminals configured for surface mounting.

Optionally, each of the one or more second extensions comprises one or more beams extending towards the contact tails of terminals adjacent a respective pair of terminals.

Optionally, the shield is a first shield attached to a first side of the housing; the plurality of openings exposing the selected terminals of the plurality of terminals are a plurality of first openings exposing the selected terminals of the plurality of terminals from the first side of the housing; the housing comprises a plurality of second openings exposing the selected terminals of the plurality of terminals from a second side of the housing, the second side opposite the first side; and the terminal assembly comprises a second shield attached to the second side of the housing, the second shield comprising portions protruding into respective openings of the plurality of second openings of the housing.

Optionally, the plurality of terminals are disposed in a pitch ranging from 0.60 mm to 0.70 mm.

Some embodiments relate to an electrical connector. The electrical connector may include a housing comprising a plurality of first grooves and a plurality of second grooves disposed alternatively in a row, and a terminal assembly. The terminal assembly may include a plurality of terminals comprising a plurality of pairs of terminals extending in the plurality of first grooves, and a plurality of single terminals extending in the plurality of second grooves, a subassembly housing, and a shield electrically contacting the plurality of single terminals.

Optionally, the housing comprises a mating face, a mounting face, and a slot recessed from the mating face; the terminal assembly is disposed on a side of the slot, each of the plurality of terminals comprising a mating end curving into the slot, a contact tail extending beyond the mounting face, and an intermediate portion between the mating end and the contact tail; and the shield is L-shaped so as to have a plurality of extensions parallel to the plurality of pairs of terminals and a plurality of protrusions electrically coupled to the plurality of single terminals.

Optionally, the housing comprises one or more receiving grooves spaced apart from the plurality of first grooves and the plurality of second grooves; and the shield extends in the one or more receiving grooves.

Optionally, for each pair of the plurality of pairs of terminals, the intermediate portions arc disposed between the slot and a respective one of the one or more receiving grooves.

Optionally, the shield comprises a body; and the plurality of extensions extending from the body into a respective one of the one or more receiving grooves and towards the mating face of the housing.

Optionally, the plurality of extensions are a plurality of first extensions extending from the body of the shield; and the shield comprises a plurality of second extensions extending from the body to outside the housing and disposed between the housing and the contact tails of the plurality of terminals.

Optionally, the shield is a first shield attached to a first side of the subassembly housing; and the terminal assembly comprises a second shield attached to a second side of the subassembly housing and electrically contacting the plurality of single terminals.

Optionally, the second shield is disposed below the slot and extends beyond the mounting face; and the first shield comprises a body and a plurality of extensions extending from the body and parallel to the contact tails of the plurality of pairs of terminals.

Some embodiments relate to an electrical connector. The electrical connector may include a housing comprising a slot, and a terminal subassembly disposed on a side of the slot of the housing. The terminal subassembly may include a plurality of terminals disposed in a row, a first shield separated from the slot of the housing by the plurality of terminals, a second shield disposed below the slot of the housing, and a subassembly housing comprising a plurality of openings through which the first and second shields can be attached to terminals configured for ground.

Optionally, the plurality of terminals comprises a plurality of pairs of first terminals and a plurality of second terminals disposed between adjacent pairs of first terminals; and both the first shield and the second shield are in electrical contact with a selected portion of the plurality of second terminals.

Some embodiments relate to a terminal assembly. The terminal assembly may comprise a plurality of terminals arranged in a row parallel to a longitudinal direction, an assembly housing holding the plurality of terminals, and a shielding subassembly attached to the assembly housing. The plurality of terminals may include a plurality of first terminals disposed in pairs and a plurality of second terminals. The pairs are dispersed among the plurality of second terminals. The assembly housing may include a plurality of opening groups exposing the plurality of second terminals respectively. The shielding subassembly may have a plurality of protrusion groups in electrical contact with the plurality of second terminals via the plurality of opening groups respectively. The plurality of terminals may have a first side and a second side opposite in a transverse direction perpendicular to the longitudinal direction. The shielding subassembly may include a first shield on the first side of the plurality of terminals. Each of the plurality of protrusion groups may include a first protrusion, and each of the plurality of opening groups may include a first opening. The first protrusion may be inserted into the first opening to be in electrical contact with a corresponding second terminal.

Optionally, each of the plurality of terminals may include a mating end and a contact tail opposite in a length direction of a corresponding terminal, and an intermediate portion held on the assembly housing and joining the mating end and the contact tail. The mating end may be bent towards the first side, and the first shield is aligned to the intermediate portion.

Optionally, the first shield further may include a plurality of projections corresponding to the pairs, the plurality of projections may protrude beyond the assembly housing towards mating ends of the plurality of terminals and may be spaced apart along the longitudinal direction.

Optionally, the first shield may protrude beyond the assembly housing towards the contact tails of the plurality of terminals.

Optionally, each of the plurality of protrusion groups may include two first protrusions. Each of the plurality of opening groups may include two first openings. A first rib may be formed between the two first openings. The two first protrusions may be spaced apart along the length direction to form a first gap. The first rib may be inserted into the first gap. The two first protrusions may be inserted into the two first openings to electrically contact a single second terminal, respectively. The two first protrusions may extend to edges of the first shield in the length direction, respectively.

Optionally, each protrusion in the plurality of protrusion groups may have a flat contact surface that contacts the corresponding second terminal. For each protrusion in the plurality of protrusion groups, the protrusion may have edges opposite along a length direction of a corresponding terminal, and the edges may be unconnected to other parts of the first shield, so that the contact surface runs through the protrusion along the length direction.

Optionally, each of the plurality of opening groups may further include a second opening in the assembly housing. The shielding subassembly may further include a second shield on the second side of the plurality of terminals. Each of the plurality of protrusion groups may include a second protrusion on the second shield. The second protrusion may be inserted into the second opening to electrically contact a corresponding second terminal.

Optionally, each of the plurality of terminals may include a mating end and a contact tail opposite along a length direction of a corresponding terminal, and an intermediate portion held on the assembly housing and joining the mating end and the contact tail. The mating end may be bent towards the first side. The second shield may further include a second body and a plurality of first extensions. The second body may have a first edge and a second edge opposite in the length direction. The second protrusion may be disposed on the second body. The plurality of first extensions may extend from the first edge to mating ends of the plurality of first terminals along the length direction and may be spaced apart from the mating ends of the plurality of first terminals.

Optionally, the plurality of first extensions may be spaced apart along the longitudinal direction and corresponding to the pairs.

Optionally, each of the plurality of first extensions may include a flat portion extending along the length direction and a connecting portion joining the flat portion and the second body. The flat portion may be closer to the plurality of first terminals than the second body.

Optionally, the contact tail may be bent towards the second side. The second shield further may include a plurality of second extensions, the plurality of second extensions may be bent from the second edge of the second body towards the second side to extend to the contact tail, and the plurality of second extensions may be spaced apart from contact tails of the plurality of first terminals.

Optionally, the plurality of second extensions may be spaced apart along the longitudinal direction and corresponding to the pairs.

Optionally, each of the plurality of second extensions may have two beams opposite in the longitudinal direction. For each of the plurality of second extensions, the two beams may be bent towards second terminals on two sides of a pair of first terminals corresponding to the second extension, respectively.

Optionally, for each of the plurality of second terminals, a group of first protrusions and a group of second protrusions corresponding to the second terminal may be staggered along a length direction of the second terminal.

Optionally, the shielding subassembly may have contact surfaces in electrical contact with and welded to the plurality of second terminals, respectively.

Optionally, the plurality of terminals may further include additional terminals, and the shielding subassembly may only span the plurality of first terminals and the plurality of second terminals along the longitudinal direction.

Optionally, no terminal may be provided between the plurality of first terminals and the plurality of second terminals.

Optionally, each of the pairs may have second terminals on two sides thereof, and the additional terminals may be disposed between adjacent second terminals.

Optionally, the additional terminals may include a plurality of additional first terminals and a plurality of additional second terminals. first terminals and second terminals may be arranged repeatedly in a predetermined pattern. The assembly housing further may include a plurality of additional opening groups, and the plurality of additional opening groups may expose the plurality of additional second terminals, respectively. A location and/or length of the shielding subassembly on the assembly housing may be configurable to be in electrical contact with second terminals through target openings, so that locations of the additional terminals relative to the plurality of terminals may be configurable.

Optionally, the pitches of the plurality of terminals may be equal. Each of the plurality of additional opening groups may be the same as any of the plurality of opening groups in structure, and opening groups may be arranged at equal intervals along the longitudinal direction.

Optionally, for the first terminals and the second terminals, every two adjacent pairs of first terminals may be separated by a second terminal, and every pair of first terminals may be disposed between two adjacent second terminals, so that the first terminals and the second terminals may be arranged repeatedly in the predetermined pattern.

Optionally, the pitches of the plurality of terminals may be less than or equal to 0.8 mm.

Some embodiments relate to a card edge connector. The card edge connector may comprises a housing and a terminal assembly. The housing may include a plurality of first grooves, a plurality of second grooves and a one or more receiving grooves. The plurality of first grooves and the plurality of second grooves may be arranged in a row parallel to a longitudinal direction. The one or more receiving grooves may be spaced apart from the plurality of first grooves in a transverse direction perpendicular to the longitudinal direction. The terminal assembly may include a plurality of terminals and a shielding subassembly. The plurality of terminals may be arranged in a row parallel to the longitudinal direction and include a plurality of first terminals extending into the plurality of first grooves and a plurality of second terminals extending into the plurality of second grooves. The plurality of first terminals may be dispersed among the plurality of second terminals in pairs. The shielding subassembly may include a plurality of first extensions inserted into the one or more receiving grooves and electrically contact with the plurality of second terminals.

Optionally, the housing may have a mating face and a mounting face opposite in a mating direction perpendicular to the transverse direction and the longitudinal direction, and a slot may be recessed inward from the mating face for receiving an add-in card. The terminal assembly may be disposed on a side of the slot. Each of the plurality of terminals may include a mating end and a contact tail opposite along a length direction of the terminal, and an intermediate portion joining the mating end and the contact tail. The mating end may be bent into the slot. The contact tail may extend beyond the mounting face. Intermediate portions of the plurality of terminals may be disposed between the slot and the one or more receiving grooves in the transverse direction. The plurality of first extensions may extend to mating ends of the plurality of first terminals.

Optionally, the terminal assembly may include an assembly housing holding the plurality of terminals. The shielding subassembly may be attached to the assembly housing. The assembly housing may include a plurality of opening groups exposing the plurality of second terminals respectively. The shielding subassembly may be in electrical contact with the plurality of second terminals via the plurality of opening groups. The housing may further include a mounting groove recessed inward from the mounting face, and the assembly housing and the shielding subassembly may be mounted into the mounting groove.

Optionally, the plurality of first grooves, the plurality of second grooves and the one or more receiving grooves may extend from the mounting groove towards the mating face. The plurality of first grooves and the plurality of second grooves may be disposed on a side wall of the slot. Mating ends of the plurality of first terminals and the plurality of second terminals may be bent from the plurality of first grooves and the plurality of second grooves into the slot, respectively.

Optionally, the plurality of terminals may have a first side and a second side opposite in the transverse direction, and the first side may be closer to the slot than the second side. The shielding subassembly may include a second shield on the second side of the plurality of terminals, and the second shield may include the plurality of first extensions.

Optionally, the contact tail may be bent towards the second side. The second shield further may include a plurality of second extensions bent towards the second side to extend to the contact tail. The plurality of second extensions may be disposed outside the housing. The plurality of second extensions may be disposed between the housing and contact tails of the plurality of terminals in the mating direction.

Optionally, the plurality of second extensions may be spaced apart along the longitudinal direction and corresponding to the pairs. Each of the plurality of second extensions may have two beams opposite along the longitudinal direction. For each of the plurality of second extensions, the two beams may be bent towards second terminals on two sides of the pair of first terminals corresponding to the second extension, respectively.

Optionally, the shielding subassembly further may include a first shield disposed on the first side of the plurality of terminals.

Optionally, the first shield may be disposed below the slot. The first shield may extend beyond the mounting face.

Optionally, the plurality of first extensions may be spaced apart along the longitudinal direction and corresponding to the pairs;

Optionally, the one or more receiving grooves may include a plurality of receiving grooves arranged in a row parallel to the longitudinal direction, and the plurality of first extensions may be inserted into the plurality of receiving grooves, respectively.

Optionally, the plurality of first extensions may have a first surface facing the plurality of terminals and a second surface opposite to the first surface in the transverse direction. The plurality of first extensions may be smaller than the one or more receiving grooves in the transverse direction, and a root of the plurality of first extensions may be bent towards the plurality of terminals, such that the first surface abuts against a wall of the one or more receiving grooves and the second surface is spaced apart from another wall of the one or more receiving grooves.

Optionally, each of the pairs may extend into a corresponding first groove.

Some embodiments relate to an electronic system. The electronic system may comprise an add-in card and an electrical connector. The add-in card may have a ground layer inside and a plurality of contact pads on a surface thereof. The electrical connector may include a slot elongating in a longitudinal direction, a plurality of terminals arranged in a row parallel to the longitudinal direction on a side of the slot, and a shielding subassembly. The add-in card may be inserted into the slot such that the plurality of contact pads are in electrical contact with the plurality of terminals. The shielding subassembly may include a first shield and a second shield disposed on two sides of the plurality of terminals opposite in a transverse direction perpendicular to the longitudinal direction, respectively. The ground layer and the first shield may be on the same side and form an inner shield for the plurality of terminals, and the second shield may form an outer shield for the plurality of terminals.

Optionally, the plurality of terminals may include a plurality of first terminals disposed in pairs and a plurality of second terminals. The pairs may be dispersed among the plurality of second terminals. Both the first shield and the second shield may be in electrical contact with the second terminals. At least a portion of the plurality of contact pads connected to the plurality of second terminals may be electrically connected to the ground layer.

These techniques may be used alone or in any suitable combination. The foregoing summary is disposed by way of illustration and is not intended to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an electronic system comprising an electrical connector mounted on a circuit board and mated with an add-in card, according to some embodiments.

FIG. 2 is a perspective view of the electronic system of FIG. 1, with the add-in card separated from the electrical connector.

FIG. 3 is a partially exploded view of the electrical connector shown in FIG. 1, according to some embodiments, with a housing exploded.

FIG. 4 is a side view of the electrical connector shown in FIG. 1.

FIG. 5 is a partially enlarged view of the electrical connector of FIG. 3 within a region circled in FIG. 4.

FIG. 6 is a cross-sectional view of the electrical connector of FIG. 4.

FIG. 7 is a cross-sectional view of the electrical connector of FIG. 6, mated with an add-in card.

FIG. 8 is an inner perspective view of a terminal assembly of the electrical connector of FIG. 3.

FIG. 9 is an inner side view of the terminal assembly of FIG. 8.

FIG. 10 is an outer perspective view of the terminal assembly of FIG. 8.

FIG. 11 is an outer side view of the terminal assembly of FIG. 10.

FIG. 12 is a side view of the terminal assembly of FIG. 8.

FIG. 13 is a partially exploded side view of the terminal assembly of FIG. 12.

FIG. 14 is a perspective view of the terminal assembly of FIG. 12.

FIG. 15 is an inner perspective view of the terminal assembly of FIG. 8, with an inner shield hidden and showing the terminals and assembly housing.

FIG. 16 is an outer perspective view of the terminal assembly of FIG. 15, with an outer shield hidden and showing the terminals and assembly housing.

FIGS. 17 to 19 are perspective and side views of the inner shield of the terminal assembly of FIG. 8.

FIGS. 20 to 23 are perspective and side views of the outer shield of the terminal assembly of FIG. 8.

FIG. 24 is a top perspective view of a portion of a housing of the electrical connector of FIG. 3.

FIG. 25 is a top perspective view of the housing shown in FIG. 24, showing the terminal assembly of FIG. 8.

FIG. 26 is a bottom perspective view of a portion of the housing of the electrical connector of FIG. 3.

FIG. 27 is a cross-sectional perspective view of the housing of FIG. 26, showing the terminal assembly of FIG. 8.

FIGS. 28A to 28F are perspective views illustrating manufacturing a first embodiment of a terminal assembly, according to some embodiments.

FIGS. 29A to 29C are perspective views illustrating manufacturing a second embodiment to a terminal assembly, according to some embodiments.

FIGS. 29D to 29E are perspective views illustrating manufacturing a third embodiment of a terminal assembly, according to some embodiments.

FIG. 29F is a perspective view illustrating manufacturing a fourth embodiment of a terminal assembly, according to some embodiments.

### DETAILED DESCRIPTION

The inventors have recognized and appreciated connector design techniques for slim, high-speed, high-density electrical connectors. Techniques described herein can enable connectors that satisfy the industry's high-speed and the high-density requirements, including those defined by standards such as Peripheral Component Interconnect Express (PCIe) Gen 6.

According to aspects of the present disclosure, a connector may include a housing with a slot between side walls, and a terminal assembly disposed between the side walls. A side wall may include first and second grooves alternatively disposed. The terminal assembly may include terminals held by an assembly housing. The terminals may include terminal pairs and single terminals extending in the first and second grooves, respectively. Inner and outer shields may be attached to opposite sides of the assembly housing and protrude into the assembly housing to contact the single terminals. The outer shield may include extensions at least partially overlapping the mating ends and contact tails of the terminal pairs, respectively. The inner shield may be configured to provide inner shielding together with a ground layer of a card inserted in the slot. Such a configuration can satisfy the industry's high-speed and the high-density requirements (e.g., 64 GT/s (giga transfers per second) with a terminal pitch of 0.65 mm).

In some embodiments, a connector may include a plurality of terminal assemblies held by a housing. Each terminal assembly may include an assembly housing and a plurality of terminals held by the assembly housing. The assembly housing may be, for example, an insulating, elongated member extending along the longitudinal direction. The plurality of terminals may be arranged in a row parallel to the longitudinal direction. The plurality of terminals may include a plurality of first terminals and a plurality of second terminals. The plurality of first terminals may be arranged in pairs dispersed among the second terminals. Exemplarily, each pair of first terminals may have second terminals on two sides thereof.

The first terminals may be used to transmit high-speed signals when the shields are attached. The assembly housing may include a plurality of opening groups that expose the plurality of second terminals, respectively. The terminal assembly may include a shielding subassembly, and the shielding subassembly may extend along the longitudinal direction. The shielding subassembly may comprise a plurality of protrusion groups. The plurality of protrusion groups may be in electrical contact with respective second terminals through the plurality of opening groups. For each pair of first terminals, adjacent second terminals and the shielding subassembly may provide enhanced shielding for the pairs of first terminals.

In some embodiments, the shielding subassembly may include an inner shield and an outer shield, which are respectively disposed on two opposite sides of the plurality of terminals along a transverse direction to enhance shielding effect. The inner shield may include a plurality of groups of first protrusions, and the outer shield may include a plurality of groups of second protrusions. Each of the opening groups in the assembly housing may include a first opening and a second opening on two sides of the plurality of terminals. Each second terminal may be exposed by a respective group of the first opening and the second opening. The first protrusions on the inner shield and the second protrusions on the outer shield may be electrically connected to the plurality of second terminals through the first openings and the second openings respectively, thereby providing enhanced shielding for the pairs of first terminals on four sides.

In some embodiments, the housing of the electrical connector may include a slot for receiving an electrical component (such as second electrical component). The electrical component may mate with the electrical connector downwardly. The terminal assembly may be installed to a side of the slot of the housing. In order to achieve a reliable electrical connection with contact pads on the electrical component and to hold the electrical component in place, the plurality of terminals of the terminal assembly may curve into the slot and be configured to exert pressure to the contact pads. Exemplarily, each terminal may include an upper mating end, a lower contact tail, and an intermediate portion joining the mating end and the contact tail. The mating end may be bent into the slot along a transverse direction and electrically contact with a respective contact pad on the electrical component. The intermediate portion may be held by the assembly housing. The contact tail may extend out of the housing for electrically contacting another electrical component (such as first electrical component).

Exemplarily, the inner shield may be disposed on an inner side of the plurality of terminals that faces the slot, and the outer shield may be disposed on an outer side of the plurality of terminals. The inner shield may be shorter than the outer shield in a mating direction of the second electrical component to the electrical connector. The mating direction is perpendicular to both the transverse direction and the longitudinal direction. Exemplarily, the inner shield may be disposed below the slot, and the top of the inner shield does not extend into the slot. The bottom of the inner shield may extend beyond the assembly housing, or even extend out of the housing, as long as it is spaced at an appropriate distance from the first electrical component. The outer shield may extend from the contact tails to the mating ends of the terminals. A ground layer may be disposed at least in a portion of the second electrical component inserted into the slot. This ground layer may provide shielding for the first terminals together with the inner shield. The outer shield may be inserted into a one or more receiving grooves in the housing for preventing the terminals from contacting the outer shield, since the terminals may deform outward under the second electrical component inserted into the slot. A plurality of first grooves and a plurality of second grooves may be provided in a side wall of the slot, and the plurality of first terminals and the plurality of second terminals may be partially accommodated in the first grooves and the second grooves, respectively. The one or more receiving grooves may be spaced apart from the first grooves along the transverse direction. The outer shield may be avoided from being short-circuited with the terminals by the one or more receiving grooves and the first grooves.

The outer shield may include a plurality of first extensions extending to overlap the mating ends of the terminals and/or a plurality of second extension extending to overlap the contact tails of the terminals. The plurality of first extensions may be inserted into the one or more receiving grooves. Exemplarily, the plurality of first extensions may correspond to a plurality of pairs of first terminals to be shielded. Accordingly, the one or more receiving grooves may include a plurality of receiving grooves for receiving the plurality of first extensions, respectively. In this way, first separators are formed between adjacent receiving grooves, which may improve the mechanical strength of the housing. The first extensions each may have a size comparable to that of a respective receiving groove in the longitudinal direction. The receiving grooves each may have a size larger than that of a respective first extension in the transverse direction. The first extensions may be bent towards the slot and abut against a side wall of the receiving groove. The first extensions may not only be positioned as desired but also be inserted into the receiving grooves against reduced resistance. Exemplarily, the plurality of second extension may correspond to the plurality of pairs of first terminals to be shielded. The second extensions are bent in the same direction as the contact tails of the terminals to provide shielding for the first terminals over a longer length. Exemplarily, the second extensions each may have two beams opposite along the longitudinal direction. The two beams may be respectively bent towards contact tails of two second terminals on two sides of the pair of first terminals shielded by the second extension. Since the second extensions may be disposed outside the housing, the second extensions may be accidentally bent towards the contact tails. The two beams of each second extension may abut against the contact tails of the two second terminals in case of an accident to avoid a short circuit with the first terminals. Optionally, the two beams of each second extension may abut against the contact tails of the two second terminals in a normal state.

In some embodiments, the terminal assembly may be assembled outside the housing and then installed into the housing. Exemplarily, a mounting groove may be recessed from a bottom surface of the housing, and the first groove, second groove and receiving groove may extend upward from the mounting groove. The shielding subassembly and the assembly housing of the terminal assembly may be inserted in the mounting groove in place. The mounting groove may be oriented in an opposite direction to the slot.

Exemplarily, the shielding subassembly may be formed with protrusions (such as first protrusions and/or second protrusions), for example, by stamping. To ensure that the position of the shielding subassembly relative to the assembly housing remains unchanged when the terminal assembly is installed in the housing and that the second conductors are in a reliable electrical contact with the shielding subassembly, exemplarily, the protrusions on the shielding subassembly may be welded to the second terminals by, for example, laser welding. Laser welding has relatively high requirements for flatness of two metal layers to be welded. Exemplarily, at least one side edge of each protrusion is not connected to other parts of the shielding subassembly. Exemplarily, two opposite side edges of each protrusion in a length direction of respective terminal are not connected to other parts of the shielding subassembly. The protrusions may be formed in the shape like a bridge by stamping. The flat surfaces of the protrusions contacting the second terminals may span the protrusions in the length direction. On this basis, the protrusions each may have a plurality of weld joints which may be arranged along the extending direction. In order to avoid affecting the welding, exemplarily, the first protrusions of the inner shield and the second protrusions of the outer shield may be staggered along the length direction.

The inventors have also recognized and appreciated that, the length and/or location of the shielding subassembly is configurable. Such a configuration may enable the terminal assembly to be used in various connectors, without altering the positions of the terminals already held by the assembly housing. For example, the terminals for transmitting high-speed signals may be used for transmitting power and/or low-speed signals by altering the length and position of the shielding subassembly. For this purpose, the plurality of terminals on the assembly housing may further include a plurality of additional terminals. The plurality of additional terminals may include additional first terminals and additional second terminals. The additional first terminals may substantially have the same structure as the first terminals for transmitting high-speed signals. The additional second terminals may substantially have the same structure as the second terminals disposed around the aforementioned first terminals. First terminals and second terminals may be repeatedly arranged in the longitudinal direction according to a predetermined pattern. A plurality of additional opening groups may be provided in the assembly housing corresponding to the additional second terminals. The shielding subassembly may be in electrical contact with more second terminals by increasing the length of the shielding subassembly, and the first terminals between these second terminals may be used for transmitting high-speed signals. Fewer first terminals may be used for transmitting high-speed signals by reducing the length of the shielding subassembly. Other terminals that are not shielded (which may include first terminals and second terminals) may be used for transmitting power and/or low-speed signals.

In some embodiments, to configure the length and/or location of the shielding subassembly expediently, terminals and opening groups (including the additional opening groups) on the assembly housing may be spaced apart uniformly on the assembly housing, and opening groups may be the same in structure. The shielding subassembly may comprise a plurality of repeating units. During the assembling of the terminal assembly, the number of units may be obtained as required, and these units may be aligned with target opening groups to make electrical contact with target second terminals.

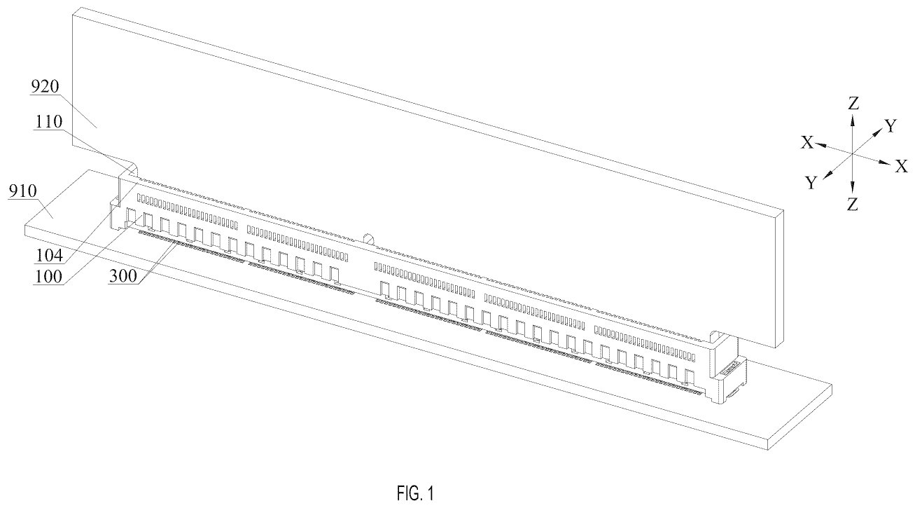

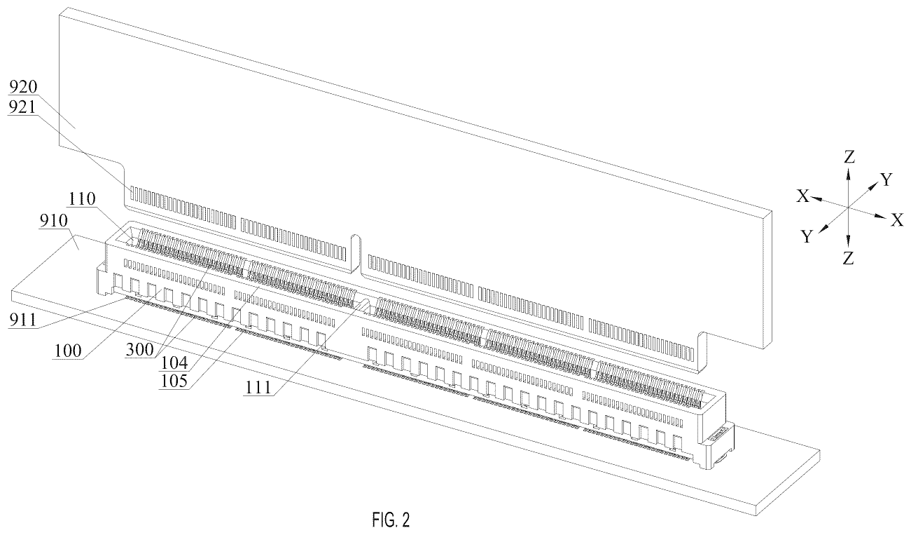

FIGS. 1-2 illustrate an electronic system, according to some embodiments. The electronic system may include an electrical connector 10. The electrical connector 10 may be configured to be installed on a first electrical component 910 in use. Exemplarily, the first electrical component 910 may include a circuit board such as a backplane, a midplane, or an add-in card, or any other suitable electrical component. The electrical connector 10 may be electrically connected to the first electrical component 910. The electrical connector 10 may also be configured to cooperate with a second electrical component 920. Exemplarily, the second electrical component 920 may include a second circuit board, such as an add-in card, a mating electrical connector, or any other suitable electrical component. The second electrical component 920 may be mated to the electrical connector 10 along a mating direction. The second electrical component 920 may be detachable from the electrical connector 10. Similarly, the electrical connector 10 may be electrically connected to the second electrical component 920, so that the first electrical component 910 and the second electrical component 920 are electrically connected through the electrical connector 10. The illustrated electrical connector 10 is a card edge connector.

Exemplarily, the electrical connector 10 may be a vertical connector, which includes a mating interface and a mounting interface opposite to each other along the mating direction. The mating interface is configured to mate with the second electrical component 920. Exemplarily, the second electrical component 920 includes a second circuit board, and the mating interface may include a slot 110 for receiving a part of the second circuit board, such as an edge of the second circuit board. Exemplarily, the second electrical component 920 includes a mating electrical connector, and the mating electrical connector may be mated to the mating interface of the electrical connector 10. The electrical connector 10 may be a socket connector or a plug connector. The mounting interface of the electrical connector 10 is configured to be mounted to the first electrical component 910. The mounting interface of the electrical connector 10 may be mounted to the first electrical component 910. Exemplarily, the electrical connector 10 may also be fixed to the first electrical component 910 through other mechanical structures such as guides and fasteners. Optionally, the electrical connector 10 may be a right-angle connector with a mating interface and a mounting interface perpendicular to the mating interface. Optionally, the electrical connector 10 may be an orthogonal connector with a mating interface and a mounting interface orthogonal to the mating interface.

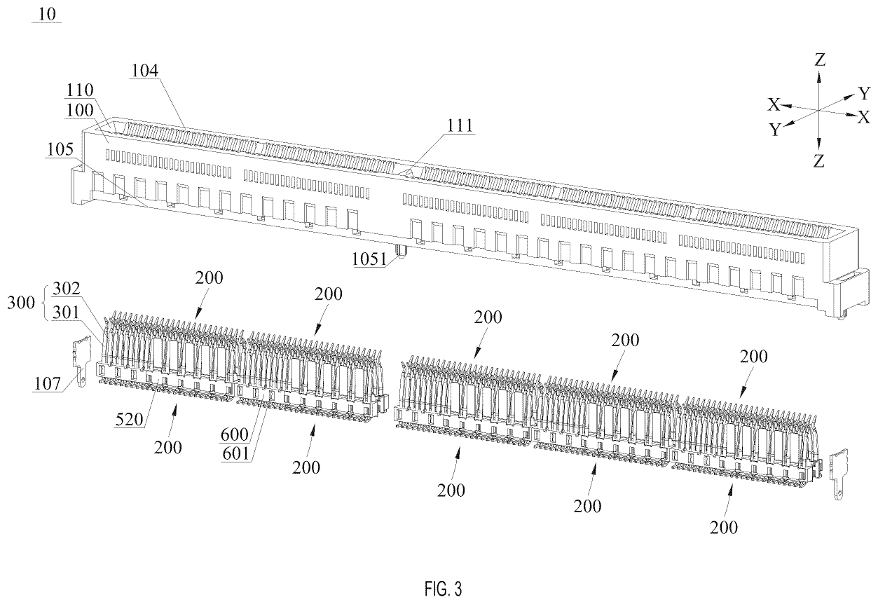

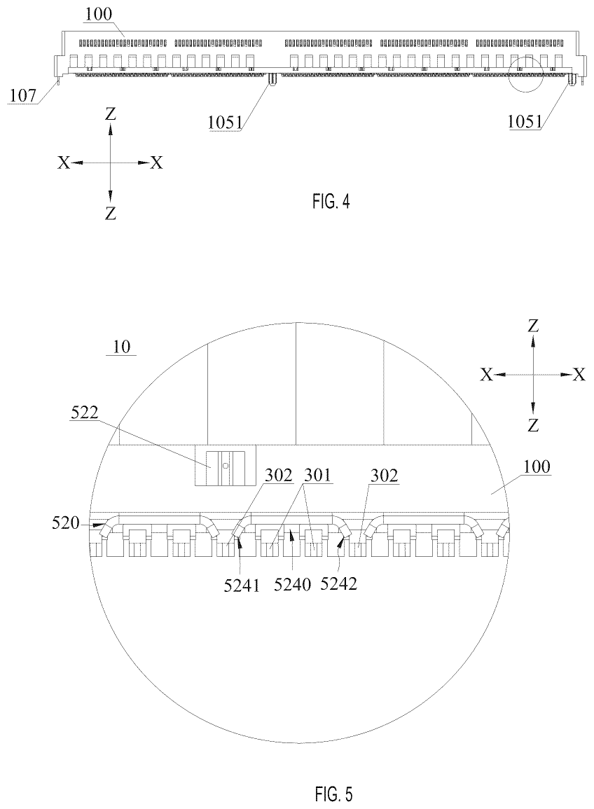

As shown in FIG. 3, the electrical connector 10 may include a housing 100 and a plurality of terminals 300. The housing 100 may be molded with insulating materials, such as plastics. Plastics may include but are not limited to liquid crystal polymers (LCP), polyphenylene sulfite (PPS), high-temperature nylon or poly-p-phenylene oxide (PPO), or polypropylene (PP), or other materials may be used. In some embodiments, plastics may be thermosetting plastics. In some embodiments, insulating plastics may include such fiberglass-reinforced insulating material. The housing 100 may generally be a one-piece component. The plurality of terminals 300 may be mounted in the housing 100. The plurality of terminals 300 may be arranged in a row parallel to the longitudinal direction X-X. The second electrical component 920 may be mated with the electrical connector 10 along the mating direction Z-Z, so that the terminals or contact pads (such as gold fingers) on the second electrical component 920 are in electrical contact with the plurality of terminals 300. In this way, the second electrical component 920 may be electrically connected to the electrical connector 10. For clarity and conciseness, a transverse direction Y-Y may also be defined, and any two of the mating direction Z-Z, the longitudinal direction X-X, and the transverse direction Y-Y may be perpendicular to each other.

Exemplarily, a slot 110 may be elongated in the housing 100 along the longitudinal direction X-X. The slot 110 may be recessed inward from the mating face 104 along the mating direction Z-Z, so as to receive a part of the second electrical component 920. The edge of the second electrical component 920 may be inserted into the slot 110. The row of the plurality of terminals 300 is arranged on a side of the slot 110. Mating ends 310 of the plurality of terminals 300 may be bent into the slot 110 to form the mating interface. When the second electrical component 920 is inserted into the slot 110 of the electrical connector 10, contact pads 921 on the surface of the second electrical component 920 may come into contact with the plurality of terminals 300, thereby forming an electrical connection. The plurality of terminals 300 may be arranged in two rows on the two opposite sides of the slot 110 along the transverse direction Y-Y, respectively. Optionally, the two rows of terminals 300 may be aligned with each other along the longitudinal direction X-X. Optionally, the two rows of terminals 300 may be staggered along the longitudinal direction X-X to increase the spacing between the terminals 300, thereby reducing crosstalk. In some embodiments, the two rows of terminals 300 may be the same in structure, but mirror-symmetrical. In some embodiments, the terminals 300 may only be disposed on one side of the slot 110, and at least portions of the terminals 300 may stretch into the slot 110 via the side wall of the slot 110.

The plurality of terminals 300 may include a plurality of first terminals 302 and a plurality of second terminals 301. A part of the plurality of terminals 300 may be first terminals 302, and another part of the plurality of terminals 300 may be second terminals 301. Optionally, the plurality of terminals 300 may also include other types of terminals. The plurality of first terminals 302 may be arranged in pairs. The plurality of first terminals 302 may be configured as differential signal pairs, for transmitting high-speed signals (such as differential signals), so as to suppress common-mode interference. Each pair of first terminals 302 may have different voltages to transmit signals. The pairs formed by the first terminals 302 may also be referred to as differential signal pairs. High-speed signals may include high data-rate signals (e.g., 64 GT/s according to PCIe Gen 6). The pairs of the first terminals 302 may be dispersed among the plurality of second terminals 301. The second terminals 301 may be configured as shielding terminals, which may be grounded and provide shielding for the first terminals 302, to alleviate the electromagnetic interference (EMI) and radio frequency interference (RFI) from external environment on the signals transmitted by the first terminals 302 and avoid the first terminals 302 from generating electromagnetic interference and radio frequency interference to the environment. Exemplarily, any two adjacent pairs of first terminals 302 may be isolated by one or more second terminals 301, so that the pairs of first terminals 302 are dispersed to reduce the interference. Exemplarily, any pair of first terminals 302 may have second terminals 301 on two sides thereof.

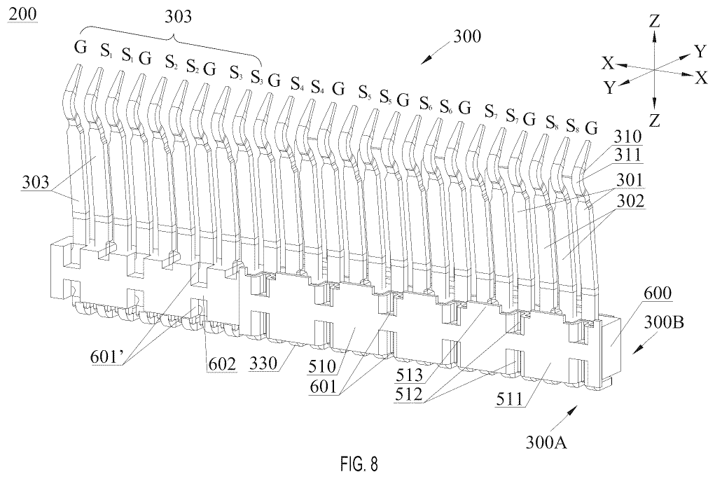

Continuing to refer to FIG. 3, the electrical connector 10 may also include an assembly housing 600, and the plurality of terminals 300 may be held by the assembly housing 600. The plurality of terminals 300 and the assembly housing 600 may together be referred to as the terminal assembly 200. FIGS. 8 to 14 show the terminal assembly 200. The plurality of terminals 300 may be held by the assembly housing 600 at intervals along the longitudinal direction X-X, such that adjacent terminals 300 are electrically insulated from each other. The terminal assembly 200 may be integrally installed into the housing 100.

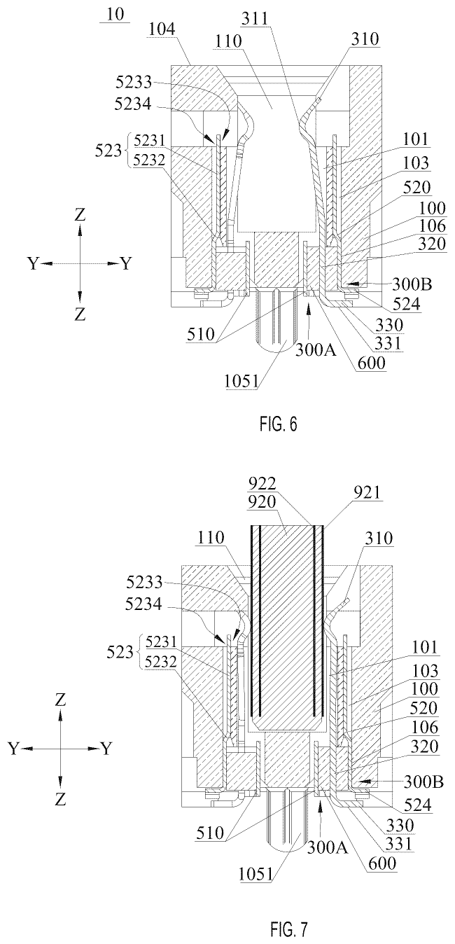

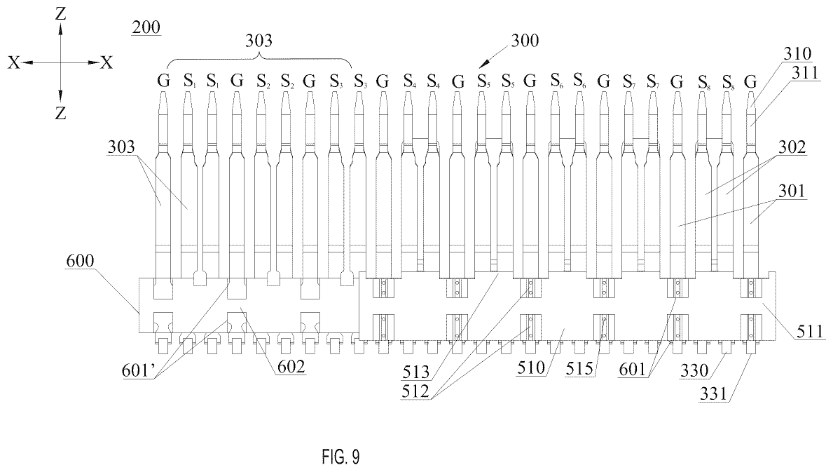

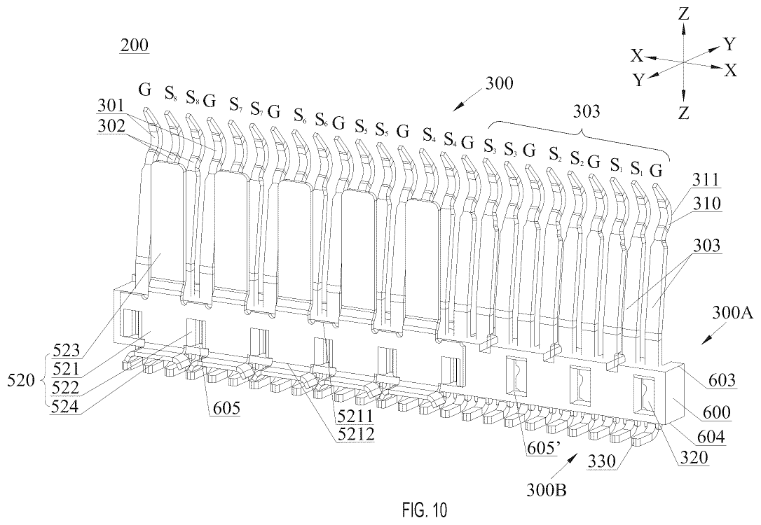

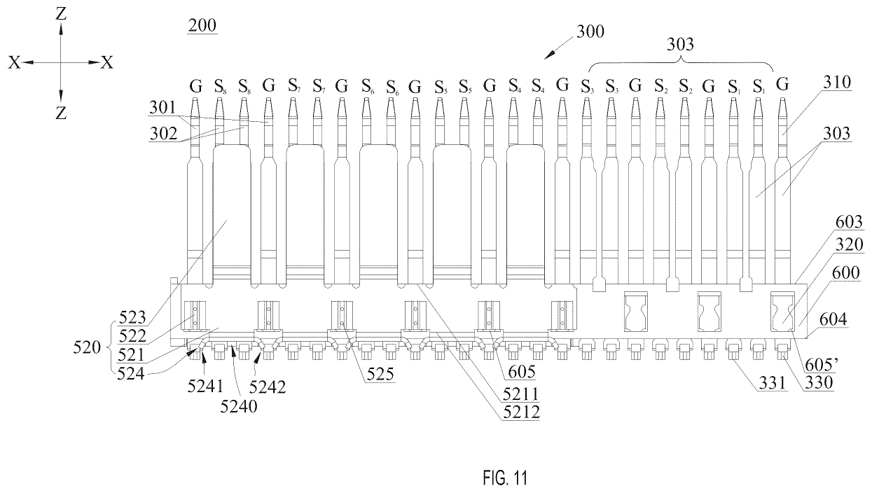

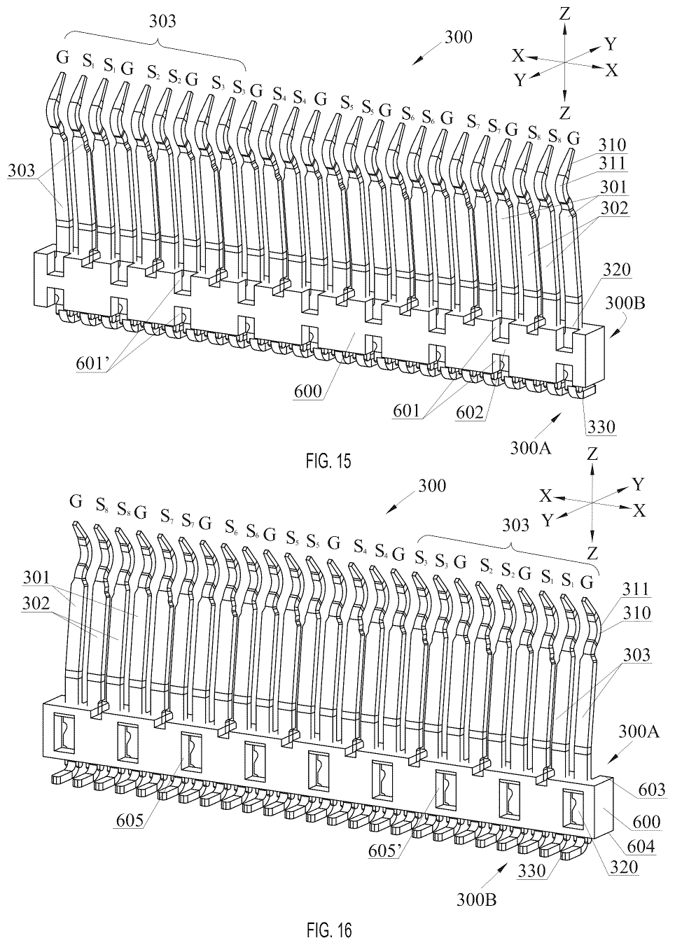

The assembly housing 600 may be molded from an insulating material, such as plastic. Exemplarily, the assembly housing 600 may be formed on the plurality of terminals 300 by insert molding. Exemplarily, the assembly housing 600 may be a pre-fabricated one-piece component with a plurality of channels, and the plurality of terminals 300 may be inserted into the plurality of channels, respectively. The assembly housing 600 may also include a plurality of opening groups, such as groups of first openings 601 in FIG. 15 and/or groups of second openings 605 in FIG. 16. The plurality of opening groups expose the plurality of second terminals 301, respectively. The plurality of opening groups may be machined after or during the insert molding of the assembly housing 600. The terminal assembly 200 may also include a shielding subassembly, such as an inner shield 510 as shown in FIGS. 8 and 9 and/or an outer shield 520 as shown in FIGS. 10 and 11. The shielding subassembly may have a plurality of protrusion groups in electrical contact with the plurality of second terminals 301 through the plurality of opening groups, respectively. The shielding subassembly may be made by a thin conductive sheet, which may reduce or eliminate external electromagnetic interference and radio frequency interference to a certain extent. The signal integrity is improved. The plurality of terminals 300 may have an inner side 300A and an outer side 300B opposite along the transverse direction Y-Y. After the terminal assembly 200 is installed in the housing 100, the inner side 300A of the plurality of terminals 300 faces the slot 110, and the outer side 300B of the plurality of terminals 300 is further from the slot 110 than the inner side 300A, as shown in FIGS. 6 and 7. There may be a terminal assembly 200 on each side of the slot 110, and the terminals 300 on two sides of the slot 110 may be mirror-symmetrical. A plurality of terminal assemblies 200 may be provided on each side of the slot 110 to improve the mechanical strength. The number of terminal assemblies 200 on each side of the slot 110 may be selected as needed.

Referring back to FIGS. 2 and 3, in the illustrated example, five terminal assemblies 200 are provided on each side of the slot 110. To improve the mechanical strength of the housing 100, a reinforcing rib 111 may be provided in the slot 110, and the reinforcing rib 111 divides the slot 110 into a first sub-slot and a second sub-slot. In some embodiments, the reinforcing rib 111 is asymmetrically arranged in the slot 110 along the longitudinal direction X-X, for example, the first sub-slot and the second sub-slot have different longitudinal lengths for fool-proofing. The terminal assemblies 200 on each side of the first sub-slot may be different from the terminal assemblies 200 on each side of the second sub-slot in number. Or optionally, the terminal assemblies 200 on each side of the first sub-slot may have a different longitudinal length from the terminal assemblies 200 on each side of the second sub-slot. In some embodiments, the pitches between adjacent terminals 300 are designed according to an industrial standard. Different terminal assemblies 200 may have a similar structure, except that the longitudinal lengths of the terminal assemblies 200 are different if the numbers of terminals 300 included in the terminal assemblies 200 are different.

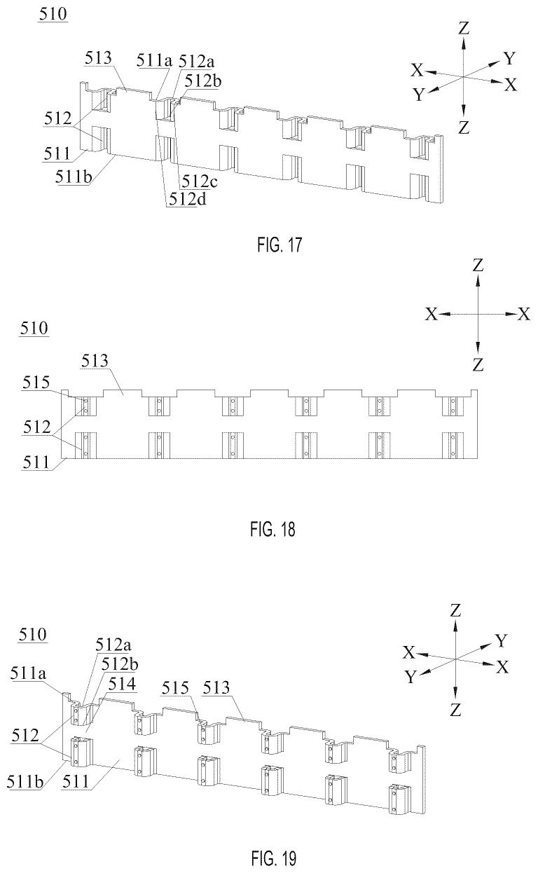

For at least a portion of the terminal assemblies 200, exemplarily, the shielding subassembly may include an inner shield 510. The inner shield 510 may be disposed on the inner side 300A of the plurality of terminals 300 and attached to the assembly housing 600. In the embodiment shown in FIGS. 17 to 19, the inner shield 510 may be made of a metal sheet. The inner shield 510 may include a plurality of groups of first protrusions 512. Each of the groups of first protrusions 512 may correspond to a second terminal 301. Each of the groups of first protrusions 512 may include one or more first protrusions 512. As shown in the figures, each of the groups of first protrusions 512 may include two first protrusions 512. The first protrusions 512 in each group may be arranged along a length direction of the terminals 300. The inner shield 510 with the first protrusions 512 may be formed by stamping a metal sheet. The costs may be lower, and shielding and mechanical properties may be better. Each of the opening groups may include a first opening 601 in the assembly housing 600. Exemplarily, the first opening 601 may expose the second terminal 301 from the inner side 300A. Each of the groups of first protrusions 512 is inserted into a corresponding first opening 601 and in electrical contact with a corresponding second terminal 301. Each pair of the first terminals 302 may be shielded by the inner shield 510 and two adjacent second terminals 301 on three sides, thereby enhancing the shielding effect. In some embodiments, two adjacent pairs of first terminals 302 may be shielded by a second terminal 301 therebetween, and the inner shield 510 may shield the electromagnetic interference on a side of the slot 110 to a certain extent. The first protrusions 512 each may be closely attached to a corresponding first opening 601. For example, the first protrusions 512 each may be in an interference fit with the corresponding first opening 601, such that the inner shield 510 is fixed to the assembly housing 600. In some embodiments, the shielding subassembly may also include an outer shield 520. The outer shield 520 may be installed on another side of the assembly housing 600 opposed to the inner shield 510. In some embodiments, the inner shield 510 and the outer shield 520 are disposed on two sides of the first terminals 302 opposed along the transverse direction Y-Y respectively, so as to surround each pair of first terminals 302 together with the second terminals 301 on four sides. In this way, the shielding effect may be further improved.

In a card edge connector, a plurality of channels may be provided in a housing, and a plurality of terminals are directly and respectively installed in the plurality of channels. This may lead to a more complex structure of the housing, especially if a card edge connector also includes a shielding subassembly. In this card edge connector, the housing may include a mounting groove for receiving the shielding subassembly, which may not only lead to a more complex structure of the housing, but also reduce the mechanical strength of the housing. With the increased number and density of the terminals, inserting the terminals into the channels in the housing respectively and being able to accurately position the terminals can significantly increase the difficulty of assembly. In some embodiments, the plurality of terminals 300 may be reliably fixed by the assembly housing 600 to form the terminal assembly 200, and the terminal assembly 200 is assembled in the housing 100, such that the pitch of the terminals 300 may be accurate. During the assembling of the terminal assembly 200 into the housing 100, the terminals 300 are uneasily skewed or short-circuited. Moreover, these terminals 300 may be respectively retained by a plurality of assembly housings 600 as desired. The structure of the housing 100 can be simpler and the mechanical strength of the housing 100 can be enhanced. The terminal assembly 200 may also include an inner shield 510. The first protrusions 512 of the inner shield 510 may be inserted into the first openings 601 of the housing 100 to electrically contact with the second terminals 301, so that the inner shield 510 and the second terminals 301 have the same potential to provide better shielding for the first terminals 302. In this way, the first terminals 302 may transmit high-speed signals in the form of differential signals, and the signal integrity (SI) is improved. The inner shield 510 may be attached to the assembly housing 600 before the terminal assembly 200 is installed in the housing 100, to simplify the structure of the housing 100. The assembly of the electrical connector 10 may be relatively simpler, and the costs may be effectively reduced.

Exemplarily, the first protrusions 512 may be welded to the second terminals 301 by any suitable method such as resistance welding, laser welding, ultrasonic welding, etc. In this way, the inner shield 510 can be electrically connected with and reliably secured to the second terminals 301, such that the shielding effect is enhanced. In some embodiments, the inner shield 510 may be installed to the assembly housing 600 holding the plurality of terminals 300 to form the terminal assembly 200, and then the terminal assembly 200 is assembled to the housing 100 by a fixture. The first protrusions 512 firmly fixed to the second terminals 301 may prevent the inner shield 510 from shifting or falling off when the terminal assembly 200 is assembled to the housing 100, thereby reducing the assembly difficulty.

Exemplarily, the terminals 300 each may be made of a conductive material such as metal. The terminal 300 each is usually an elongated one-piece component. The pitch of the plurality of terminals 300 may be less than or equal to 0.8 mm, such that the number of terminals 300 in a given area may be reduced and the terminal density of the electrical connector 10 may be increased. Exemplarily, the pitch of the plurality of terminals 300 may be between 0.6 mm and 0.7 mm. For example, the pitch of the plurality of terminals 300 may be 0.60 mm, 0.61 mm, 0.62 mm, 0.63 mm, 0.64 mm, 0.65 mm, 0.66 mm, 0.67 mm, 0.68 mm or 0.69 mm, or any intermediate value between them. The pitch of the terminals 300 can be effectively reduced under the above-mentioned shielding, so that a miniaturized, high-density connector may be provided, and the signal integrity may be improved.

As shown in FIGS. 8 to 16, exemplarily, the terminals 300 each may include a mating end 310, a contact tail 330 opposite to the mating end 310 along its length direction, and an intermediate portion 320 joining the mating end 310 and the contact tail 330. The mating end 310 may be in electrical contact with a contact pad 921 (in FIG. 2) on the second electrical component 920, and the contact tail 330 may be in electrical contact with a contact pad 911 (FIG. 2) on the first electrical component 910. The intermediate portion 320 may be held by the assembly housing 600. The intermediate portions 320 of the adjacent terminals 300 are spaced apart by the assembly housing 600 to isolate the adjacent terminals 300. The plurality of opening groups (for example, including the first openings 601 mentioned above and/or the second openings 605 to be mentioned later) may expose the intermediate portions 320 of the terminals 300 respectively, for the shielding subassembly passing through. After the assembly housing 600 assembled with the terminals 300 and the shielding subassembly is installed in the housing 100, the intermediate portions 320 may be disposed on a side of the slot 110.

The contact tails 330 of the terminals 300 may extend from the intermediate portions 320 to the outside of the assembly housing 600, and even to the outside of the housing 100 after the terminal assembly 200 is installed in the housing 100. The contact tails 330 may be connected to the first electrical component 910. The first electrical component 910 may be a printed circuit board. Optionally, the contact tails 330 may be shaped as flexible portions for pressure mounting. The first electrical component 910 may be provided with a plurality of contact pads 911 corresponding to the plurality of terminals 300, and these contact pads 911 may be electrically connected to one or more layers of conductive traces in the first electrical component 910. The electrical connector 10 may be reliably fixed to the first electrical component 910 under pressure, while the contact tails 330 may be reliably electrically connected to the contact pads 911. In some embodiments not shown, the contact tails of the plurality of terminals may be soldered to the pads on the first electrical component 910 through technologies such as surface mount technology (SMT) and/or through-hole technology (THT), so as to electrically connect to circuits of the circuit board. In some other embodiments, the contact tails 330 each may be connected with a fusible element, such as a solder ball like a tin ball, and the contact tails 330 each may be soldered to a respective contact pad 911 on the first electrical component 910 through a solder ball. The contact tails 330 may be electrically connected to the circuit board based on any suitable technology, as long as the electrical connector 10 may be used to interconnect an add-in card to circuits of the circuit board. Exemplarily, the contact tails 330 of the terminals 300 in each row may be arranged in a row. Or optionally, any two adjacent contact tails 330 in each row may respectively deviate from the row in opposite directions, so as to increase the distance between the two adjacent contact tails 330. In this way, the spacing between the adjacent conductive vias or contact pads 911 of the first electrical component 910 may be increased, and the spacing between the terminals 300 may be further reduced.

Referring to FIGS. 6 and 7, the mating ends 310 may be bent into the slot 110 to form protrusions facing the inner side 300A where the inner shield 510 is disposed. The mating ends 310 may include contact surfaces 311 on the protrusions to smoothly contact with the contact pads 921 on the second electrical component 920, so as to avoid scratching the contact pads 921. When the second electrical component 920 is inserted into the slot 110, the contact surfaces 311 on the mating ends 310 may electrically contact with the contact pads 921 on the second electrical component 920 respectively, such that the terminals 300 are electrically connected to the circuits of the second electrical component 920. One end of each mating end 310 is connected to the intermediate portion 320, and the other end is a free end, so that the mating end 310 has elasticity. After the second electrical component 920 is inserted into the slot 110, the mating ends 310 may be pressured towards the outside of the slot 110 along the transverse direction Y-Y, and the mating ends 310 may reliably abut against and be in electrical contact with the contact pads 921 of the second electrical component 920 under the elasticity.

The inner shield 510 may be aligned the intermediate portions 320 of the terminals 300 on the inner side 300A, and do not extend to the side of the mating ends 310. In this way, the inner shield 510 is prevented from contacting the mating ends 310 bent towards the inner side 300A, and the first electrical component 910 can be inserted into the slot 110 without interference. In some embodiments, the inner shield 510 may not extend into the slot 110, but is below the slot 110. The inner shield 510 may abut against the assembly housing 600 that holds the intermediate portions 320, and the inner shield 510 is spaced apart from the first terminals 302 through the assembly housing 600 to avoid signal attenuation. When the assembly housing 600 and the inner shield 510 are installed in the housing 100, the inner shield 510 may be clamped by the assembly housing 600 and the housing 100 in the transverse direction Y-Y, and the first protrusions 512 of the inner shield 510 are unlikely to separate from the second terminals 301.

The second electrical component 920 may be a multi-layer circuit board including a ground layer 922. As shown in FIG. 7, after the second electrical component 920 is inserted into the slot 110, the inner shield 510 and the ground layer 922 of the second electrical component 920 may form a relatively complete shielding protection for the first terminals 302 and the contact pads 921 electrically connected to the first terminals 302 on the inner side 300A, thereby improving the signal integrity of the first terminals 302. Exemplarily, a portion of the contact pads 921 connected to the second terminals 301 may be electrically connected to the ground layer 922, so that the ground layer 922, the shielding subassembly and the second terminals 301 have the same potential. The shielding protection can be improved.

Exemplarily, the inner shield 510 may further include a plurality of projections 513 extending towards the mating end 310 beyond the assembly housing 600. With reference to FIGS. 8 to 9 and FIGS. 17 to 19, the inner shield 510 may include a first body 511 with the plurality of projections 513 disposed thereon. The plurality of projections 513 are spaced apart along the longitudinal direction X-X, and the plurality of projections 513 are corresponding to the plurality of pairs of first terminals 302. Each pair of first terminals 302 corresponds to a projection 513. Referring back to FIGS. 6 to 7, portions of the inner shield 510 corresponding to the pairs of first terminals 302 have an increased dimension (such as height) in the extending direction of the first terminals 302. The shielding effect on the first terminals 302 may be further enhanced, and the signal integrity may be improved. The projections 513 are closer to the slot 110 than other parts of the inner shield 510, and thus may be closer to the ground layer 922 in the second electrical component 920. However, optionally, the projections 513 may be disposed below the slot 110. Optionally, the tops of the projections 513 are flush with the bottom surface of the slot 110. It may be understood that the present application does not exclude the embodiment where the tops of the projections 513 extends into the slot 110. The projections 513 may extend into the housing 100, and the housing 100 may include second separators 109 (see FIG. 27) between the projections 513, thereby improving the mechanical strength of the housing 100. The first protrusions 512 may be disposed on the first body 511. The first protrusions 512 may be disposed between the projections 513 along the longitudinal direction X-X. On the one hand, this may facilitate the first protrusions 512 to make electrical contact with the second terminals 301; on the other hand, the portions of the inner shield 510 corresponding to the first terminals 302 may be more flat. The distance between the first terminals 302 and the inner shield 510 is uniform along the extending direction of the first terminals 302.

Exemplarily, the inner shield 510 protrudes beyond the assembly housing 600 towards the contact tails 330. The contact tails 330 needs to be mounted to the first electrical component 910 such as a printed circuit board. There may be many traces in the printed circuit board, and some of the traces may run through below the electrical connector 10. To prevent the electromagnetic waves and radio frequency interference generated by these traces from interfering with the signals transmitted by the first terminals 302, as much shielding as possible may be provided along the length (i.e., extending direction) of the first terminals 302. As shown in FIGS. 6 to 9, a lower end of the inner shield 510 protrudes beyond the assembly housing 600. However, the lower end of the inner shield 510 is higher than bottom surfaces 331 of the contact tails 330. When the electrical connector 10 is mounted to the first electrical component 910, the lower end of the inner shield 510 may be spaced apart from the first electrical component 910 to avoid the inner shield 510 from making electrical contact with the contact pads 911 on the first electrical component 910 connected to the first terminals 302.

With reference to FIGS. 8 to 9 and FIGS. 13 to 14, exemplarily, each of the groups of the first protrusions 512 may include two first protrusions 512. Correspondingly, each of the opening groups in the assembly housing 600 may include two first openings 601. A first rib 602 is formed between the two first openings 601, as shown in FIG. 15. The two first protrusions 512 are spaced apart along the extending direction of the second terminal 301 and form a first gap 514. The first rib 602 is inserted into the first gap 514. The two first protrusions 512 in each group respectively extend into the two first openings 601 to make electrical contact with a corresponding second terminal 301. In this way, the contact resistance between the inner shield 510 and the second terminal 301 may be reduced, and the shielding effect may be improved.

Exemplarily, the two first protrusions 512 oppositely extend to edges 511a and 511b of the inner shield 510 in the extending direction of the second terminal 301, respectively. The two edges 511a and 511b are opposed along the extending direction of the second terminal 301, such that the two first protrusions 512 can have sufficient height. Referring to FIGS. 17 and 19, the two first openings 601 may also extend to edges of the assembly housing 600, respectively. The inner shield 510 with the first protrusions 512 may be formed of a metal sheet by stamping. It is desirable that protruding surfaces of the first protrusions 512 are as flat as possible for contacting the second terminal 301. The flat protruding surfaces may increase the contact area between the first protrusions 512 and the second terminal 301, and there is almost no gap or chamber between the first protrusions 512 and the second terminal 301. In the case where the first protrusions 512 are connected to the second terminals 301 by welding, such as laser welding, the gap or chamber between two metal sheets to be connected may lead to uneven temperature distribution at weld joints. There may be defects such as pores and collapses at the weld joints, and in extreme cases, an upper metal sheet may even be welded through without being connected to a lower metal sheet, which can affect the mechanical and electrical properties. As shown in the figures, the first protrusions 512 in the upper row may extend to the edge 511a of the inner shield 510, and the first protrusions 512 in the lower row may extend to the edge 511b of the inner shield 510. In this way, at least one side of each of the first protrusions 512 is not connected to other parts of the inner shield 510. Compared with the structure where all four sides of each first protrusion 512 are connected to other parts of the inner shield 510 to form a structure similar to a “dome”, the first protrusions 512 each may have a larger flat contact surface by making at least one side of each first protrusion 512 free. It may be beneficial for the welding, especially when the size of the first protrusions 512 on the inner shield 510 is limited. In some embodiments, if the flat contact surface of the first protrusions 512 is larger, a plurality of first weld joints 515 may be formed between each first protrusion 512 and the inner shield 510, thereby improving the mechanical connection strength therebetween and reducing the contact resistance.

In order to further increase the area of the flat contact surfaces of the first protrusions 512, exemplarily, a side of each of the first protrusions 512 opposed to the side extending to the edge of the inner shield 510 may also not be connected to other parts of the inner shield 510. Taking the upper row of the first protrusions 512 as an example, the first protrusions 512 each may have edges 512a and 512b opposite along the extending direction of the second terminals 301. The edge 512a at the edge 511a of the inner shield 510 is not connected to other parts of the inner shield 510. A slit may be formed between the edge 512b and other parts of the inner shield 510, so that the edge 512b is also not connected to other parts of the inner shield 510. The first protrusions 512 may be stamped in the shape of “bridge”, such that each of the flat contact surfaces of the first protrusions 512 may extend from the edge 512a to the edge 512b. A plurality of first weld joints 515 for joining each of the first protrusions 512 to the second terminal 301 may be arranged along the extending direction of the second terminal 301. Optionally, in the electrical connector 10 shown in the figures, the inner shield 510 is usually formed by a thin metal sheet, which may have a thickness in a range of 0.1 mm-0.15 mm, or smaller. In this case, edges 512c and 512d of the first protrusions 512 opposite along the longitudinal direction X-X may be connected to other parts of the inner shield 510, such that the mechanical strength of the first protrusions 512 can be improved with less deformation. The fact that only two sides of the first protrusions 512 are connected to other parts of the inner shield 510 may also avoid problems such as the metal sheet being broken due to a large degree of stretching when the first protrusions 512 are formed by stamping the metal sheet.

Optionally, only a larger first protrusion is provided for each of the second terminals 301. For example, along the extending direction of the second terminals 301, the larger first protrusion may be disposed near an edge of the inner shield 510 or in the middle of the inner shield 510. In this case, it is also possible for the edges 512a and 512b of the first protrusion to be unconnected to other parts of the inner shield 510.

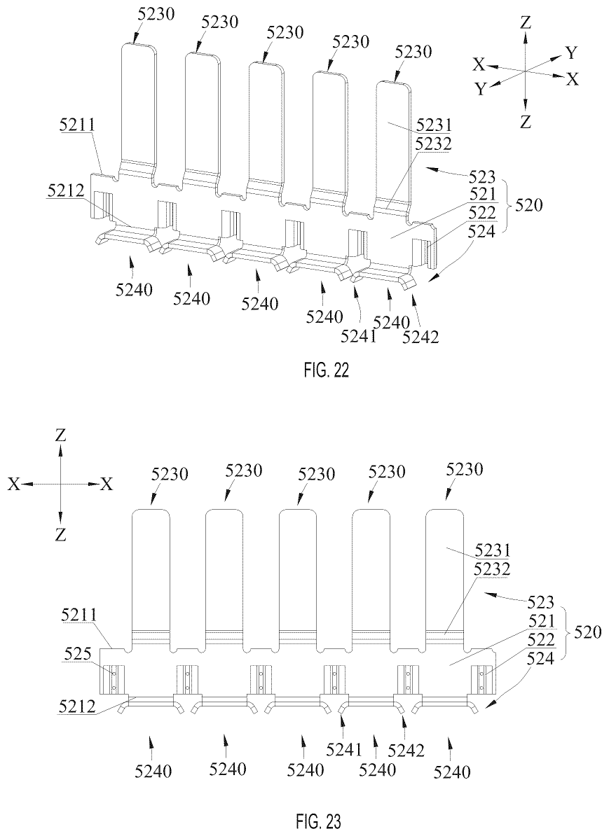

As shown in FIGS. 10 to 14, FIG. 16 and FIGS. 20 to 23, exemplarily, the shielding subassembly may further include an outer shield 520. The outer shield 520 is on the outer side 300B of the plurality of terminals 300, and attached to the assembly housing 600. Each of opening groups in the assembly housing 600 may further include a second opening 605 on the outer side 300B of the terminal 300. The outer shield 520 may include a plurality of groups of second protrusions 522, and each of groups of second protrusions 522 may be inserted into a corresponding second opening 605 and contact a corresponding second terminal 301. Each pair of first terminals 302 is shielded by the inner shield 510 and the outer shield 520 on two sides opposed in the transverse direction Y-Y, respectively. Also, each pair of first terminals 302 is shielded by at least two second terminals 301 on two sides opposed in the longitudinal direction X-X, respectively. Moreover, both the inner shield 510 and the outer shield 520 are in electrical contact with at least two second terminals 301. The conductors surrounding each pair of first terminals 302 have the same potential for shielding each pair of first terminals 302 on four sides. The signal integrity is improved. The outer shield 520 may also be positioned by the second protrusions 522 inserted into the second openings 605, thereby ensuring the relative position between the outer shield 520 and the assembly housing 600. The assembling of the terminal assembly 200 to the housing 100 is simpler. Exemplarily, the plurality of groups of second protrusions 522 may be respectively welded to the plurality of second terminals 301 by any suitable method, such as resistance welding, laser welding, ultrasonic welding, etc., so that the outer shield 520 can be electrically connected and fixed to the first terminals 302 reliably.

Exemplarily, the outer shield 520 with the second protrusions 522 may be formed by stamping a metal sheet, such that the costs can be lower and the shielding and mechanical properties can be improved. It is desirable that the protruding surfaces of the second protrusions 522 are as flat as possible for contacting the second terminals 301. The flat protruding surfaces may increase the contact area between the second protrusions 522 and the second terminals 301, and there is almost no gap or chamber between the second protrusions 522 and the second terminals 301. In the case where the second protrusions 522 are connected to the second terminals 301 by welding, such as laser welding, almost no defects that affect the mechanical and electrical properties may be created at the weld joints. In some embodiments, if the flat contact surfaces on the second protrusions 522 are larger, a plurality of second weld joints 525 may be formed for connecting each second protrusion 522 and the outer shield 520, thereby improving the mechanical connection strength therebetween and reducing the contact resistance.

In order to further increase the area of the flat contact surface of each second protrusion 522, at least one side of each second protrusion 522 may be unconnected to other parts of the outer shield 520, rather than a second protrusion having a structure similar to a “dome” with four sides connected to other parts of the outer shield 520. Each second protrusion 522 may have edges 522a and 522b opposite along the extending direction of the second terminal 301. One of the edges 522a and 522b may also extend to the edge of the outer shield 520. For example, the edge 522b of the second protrusion 522 extends to the second edge 5212 of the outer shield 520. The other, such as the edge 522a may be spaced apart from the other parts of the outer shield 520. For example, a slit is formed between the edge 522a of each second protrusion 522 and the other parts of the outer shield 520. The second protrusions 522 may be stamped in the shape of “bridge”, and each of the flat contact surfaces of the second protrusions 522 may extend from the edge 522a to the edge 522b. A plurality of second weld joints 525 for joining each of the second protrusions 522 to the second terminal 301 may be arranged along the extending direction of the second terminal 301. Optionally, the outer shield 520 is usually formed by a thin metal sheet, which may have a thickness approximately in a range of 0.1 mm-0.15 mm or smaller. In this case, edges 522c and 522d of the second protrusions 522 opposite along the longitudinal direction X-X may be connected to other parts of the outer shield 520, such that the mechanical strength of the second protrusions 522 can be improved with less deformation. The fact that only two sides of the second protrusions 522 are connected to other parts of the outer shield 520 may also avoid problems such as the metal sheet being broken due to a large degree of stretching when the second protrusions 522 are formed by stamping the metal sheet.

Optionally, it is also possible to arrange the second protrusions in the middle of the outer shield 520 along the extending direction of the second terminal 301. In this case, the edges 522a and 522b of the second protrusions opposite along the extending direction may be spaced apart from other parts of the outer shield 520, so as to be unconnected to other parts of the outer shield 520.

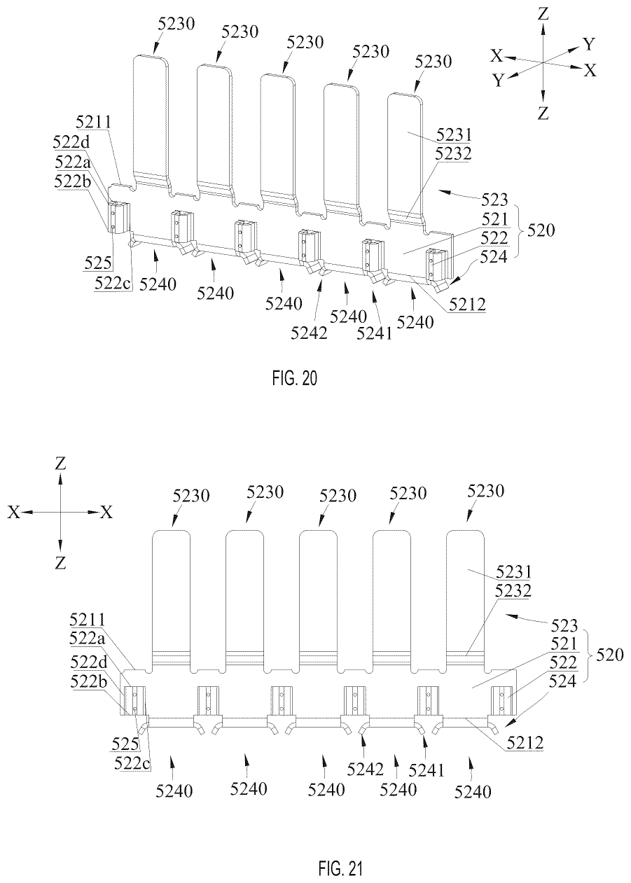

With reference to FIGS. 20 to 23, exemplarily, the outer shield 520 may further include a second body 521 and a plurality of first extensions 523. In the illustrated embodiment, as the outer shield 520 is attached to the assembly housing 600, the second body 521 may substantially have the same dimension as the assembly housing 600 in the mating direction Z-Z. The second body 521 has a first edge 5211 and a second edge 5212 opposite along the extending direction of the second terminal 301. The first edge 5211 may face the mating face 104 of the housing 100, and the second edge 5212 may face the mounting face 105 of the housing 100. In the drawings, the first edge 5211 is disposed above the second edge 5212. The first edge 5211 may be substantially flush with the upper edge of the assembly housing 600, and the second edge 5212 may be substantially flush with the lower edge of the assembly housing 600 or not extend to the lower edge of the assembly housing 600. It should be appreciated that the present application does not exclude the embodiment where the assembly housing 600 has another dimension in the mating direction Z-Z. The groups of second protrusions 522 may be disposed on the second body 521 and inserted into the second openings 605 of the assembly housing 600, such that the second protrusions 522 can electrically contact with the second terminals 301.

The plurality of first extensions 523 may extend from the first edge 5211 to the mating ends 310 of the first terminals 302 along the extending direction, and the plurality of first extensions 523 is spaced apart from the mating ends 310 of the first terminals 302. In some embodiments, the projections 513 of the inner shield 510 and the ground layer 922 of the second electrical component 920 may form an inner shielding for the first terminals 302 on the inner side 300A. The outer shield 520 with the plurality of first extensions 523 on the outer side 300B may form as much outer shielding as possible along the extending direction of the first terminals 302. The first terminals 302 can be shielded by the plurality of first extensions 523. The housing 100 may include a one or more receiving grooves 103 for receiving the plurality of first extensions 523, as shown in FIGS. 6 and 7, such that the plurality of first extensions 523 is prevented from contacting the first terminals 302 because of the situations, such as the plurality of first extensions 523 being bent, and the first terminals 302 being biased towards the outer side 300B under the extrusion of the second electrical component 920. The one or more receiving grooves 103 may be disposed outside the slot 110 along the transverse direction Y-Y. The first terminals 302 may be bent into the slot 110, so that the first terminals 302 are spaced apart from the plurality of first extensions 523. The first terminals 302 and the plurality of first extensions 523 may be separated by the housing 100.

Exemplarily, the plurality of first extensions 523 may be provided only on the outer side 300B of the pairs of the first terminals 302. The plurality of first extensions 523 may be spaced apart along the longitudinal direction X-X and aligned with the pairs of the first terminals 302, respectively. The gaps between adjacent first extensions 5230 may be aligned with the second terminals 301. Based on this, a plurality of receiving grooves 103 are arranged along the longitudinal direction X-X in the housing 100, and the first extensions 5230 may be inserted into the receiving grooves 103, respectively. The first separators 108 between adjacent receiving grooves 103 can strengthen the housing 100, thereby improving the mechanical strength of the housing 100. In other embodiments not shown, a plurality of first extensions may extend continuously along the longitudinal direction X-X to cross the pairs of the first terminals 302. Correspondingly, a one or more receiving grooves in the housing 100 may have a longer length along the longitudinal direction X-X to accommodate the continuous plurality of first extensions.

Exemplarily, as shown in FIGS. 6 to 7 and FIG. 14, the first extensions 5230 each may include a flat portion 5231 extending along the extending direction of the first terminals 302 and a connecting portion 5232 connected between the flat portion 5231 and the second body 521. The flat portion 5231 is closer to the terminal 300 than the second body 521 in the transverse direction Y-Y. The connecting portion 5232 is inclined from the second body 521 to the flat portion 5231 towards the terminal 300. The better shielding effect may be achieved by placing the shielding subassembly at a smaller distance around the first terminals 302 to be shielded. However, the assembly housing 600 needs a certain dimension in the transverse direction Y-Y to ensure the mechanical strength. If it is necessary to bring the first extension 5230 closer to a respective first terminals 302, the first extension 5230 may be bent towards the slot 110 through the connecting portion 5232, and the flat portion 5231 may be above the connecting portion 5232. Exemplarily, the flat portion 5231 may run parallel to the mating direction Z-Z, so as to be substantially parallel to the respective first terminal 302 pressed outwardly by the second electrical component 920 inserted into the slot 110, as shown in FIG. 7. In this way, the shielding effect can be enhanced.

Exemplarily, as shown in FIGS. 13 and 14, for each second terminal 301, the first protrusions 512 of the inner shield 510 and the second protrusions 522 of the outer shield 520 may be non-aligned along the extending direction of the second terminals 301. The first protrusions 512 and the second protrusions 522 may be welded to the second terminals 301 from the inner side 300A and the outer side 300B, respectively. If the first protrusions 512 and the second protrusions 522 are aligned along the extending direction of the second terminal 301, the first weld joints 515 between the first protrusions 512 and the second terminals 301 and the second weld joints 525 between the second protrusions 522 and the second terminals 301 may be relatively close or even overlapping, which may affect the welding process. In the welding process, if the first weld joints 515 and the second weld joints 525 overlap, the second terminals 301 may be damaged or even broken. In some embodiments, it is desired to completely stagger the first weld joints 515 and the second weld joints 525 along the extending direction of the second terminals 301. If the first protrusions 512 and the second protrusions 522 are symmetrically disposed on two sides of the second terminal 301, it is difficult to completely stagger the first weld joints 515 and the second weld joints 525 since the areas of the first protrusions 512 and the second protrusions 522 are limited. The first protrusions 512 is non-aligned with the second protrusions 522 in the mating direction Z-Z, such that the first weld joints 515 and the second weld joints 525 may be completely staggered. The yield of welding can be effectively improved. Exemplarily, each of the groups of second protrusions 522 may include one or more second protrusions 522, as desired.

With reference to FIGS. 10 and 11, exemplarily, the contact tails 330 of the terminals 300 may be bent towards the outer side 300B, so as to increase the distance between the contact tails 330 of the terminals 300 on two sides of the slot 110 and reduce crosstalk. Also, the contact pads 911 can be easily processed on the first electrical component 910 for contacting the contact tails 330. The second body 521 of the outer shield 520 may be shorter in the mating direction Z-Z to avoid the second edge 5212 of the second body 521 of the outer shield 520 being too close to the contact tail 330. If two second protrusions 522 are provided on the second body 521 for a respective second terminal 301, similar to the inner shield 510, each of the second protrusions 522 may be shortened in the mating direction Z-Z. In this way, it may be more difficult to weld the second protrusions 522 to the second terminals 301, and it is uneasy to stagger them from the first protrusions 512. Also, the mechanical strength of the assembly housing 600 may be reduced, if the assembly housing 600 includes two first openings 601 and two second openings 605 for receiving the first protrusions 512 and second protrusions 522 corresponding to each second terminal 301. Accordingly, a single second protrusion 522 may be disposed corresponding to each second terminal 301. The dimension of the second protrusion 522 may be not smaller than that of the first protrusion 512 in the extending direction of the terminals 300, and the second protrusion 522 may be disposed between the two first protrusions 512 in the extending direction of the terminal 300, such that the second protrusion 522 may be staggered from the first protrusions 512. The welding quality can be improved. Portions of the assembly housing 600 other than the first openings 601 and the second openings 605 are also used to cover and fix the second terminals 301. A portion of the assembly housing 600 may provide a first fixing point between the two first openings 601 on one side of the second terminal 301, and portions of the assembly housing 600 above and below the second opening 605 may provide a second fixing point and a third fixing point on the other side of the second terminal 301, respectively. These three fixing points are staggered along the extending direction of the terminal 300, so that the second terminal 301 may be reliably fixed to the assembly housing 600. The second terminals 301 are uneasy to be peeled off from the assembly housing 600 under external forces. Exemplarily, in order to position the outer shield 520, the second openings 605 each may be disposed in the middle of the assembly housing 600 along the extending direction of the terminals. The second protrusions 522 can be positioned by four side edges of the second opening 605, such that the outer shield 520 can be held on the assembly housing 600 in place.

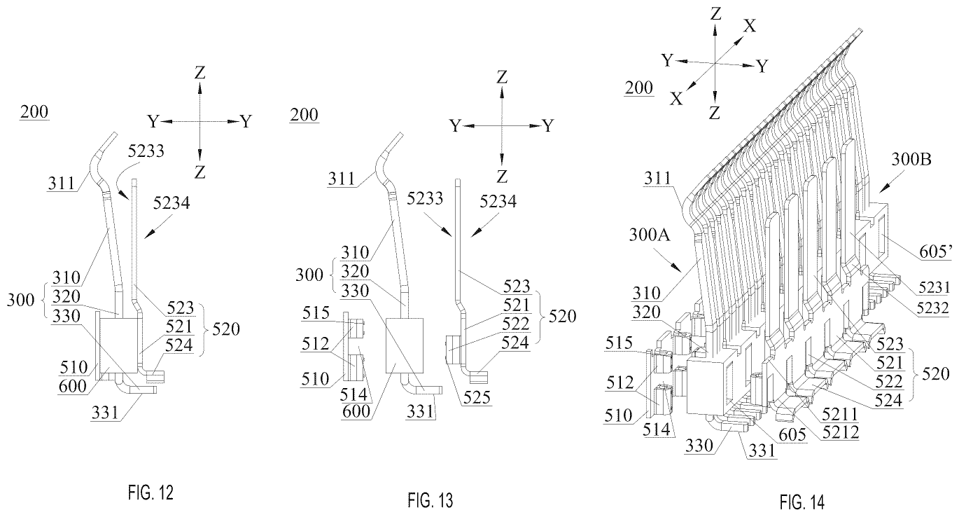

Exemplarily, the outer shield 520 may further include a plurality of second extension 524, and the plurality of first extensions 523 and the plurality of second extension 524 extend from the second body 521 in opposite directions. Portions of the terminals below the second body 521 can be shielded by the plurality of second extension 524. In the case where the contact tails 330 are bent towards the outer side 300B, the plurality of second extension 524 may be bent from the second edge 5212 of the second body 521 to the contact tails 330 of the terminals 300 towards the outer side 300B of the terminals 300. In this way, a better shielding effect may be achieved along the extending direction of the first terminals 302. The plurality of second extension 524 is spaced apart from the contact tails 330 of the plurality of first terminals 302. A portion of the plurality of second extensions 524 close to a distal end thereof may be parallel to the contact tails 330 of the terminals 300. Shielding may be provided above the contact tail 330, as shown in FIG. 12. The plurality of second extensions 524 may be disposed between the housing 100 and the contact tails 330 of the plurality of terminals 300 in the mating direction Z-Z. The plurality of second extensions 524 may not protrude from the housing 100 in the transverse direction Y-Y. After the electrical connector 10 is mounted onto the printed circuit board, there is almost no possibility that the plurality of second extensions 524 is accessed, and the plurality of second extensions 524 may be effectively prevented from being deformed and contacting the first terminals 302.

With reference to FIGS. 20 to 23, exemplarily, the plurality of second extensions 524 may be spaced apart along the longitudinal direction X-X, The plurality of second extensions 5240 are correspondingly arranged with the pairs of the first terminals 302. The gaps between adjacent second extensions 5240 may be aligned with the second terminals 301. The second protrusions 522 each may be disposed between the second extensions 5240, respectively. The second protrusions 522 may extend to the second edge 5212 of the second body 521 of the outer shield 520. During the mounting of the electrical connector 10 onto the first electrical component 910 and/or during the storage or transportation of the electrical connector 10, the plurality of second extensions 524 may be bent towards the contact tails 330 of the terminals 300 due to external forces. The plurality of second extensions 524 may be configured to include a plurality of independent second extensions 5240, which may prevent the plurality of second extensions 524 from being deformed as a whole towards the contact tail 330 anywhere.

Further, the second extensions 5240 each may have two beams 5241 and 5242 opposite along the longitudinal direction X-X. The two beams 5241 and 5242 of each of the second extension 5240 may be bent towards the second terminals 301 on two sides of a corresponding pair of first terminals 302, respectively (see FIGS. 5 and 11). Even if a second extension 5240 is deformed by external force, the downwardly bent beams 5241 and 5242 of the second extension 5240 may abut against the contact tails 330 of the second terminals 301 rather than a straight portion connected between the beams 5241 and 5242. The second extension 5240 may be supported on the contact tail 330 of the second terminal 301 without causing electrical contact with the contact tail 330 of the first terminal 302.

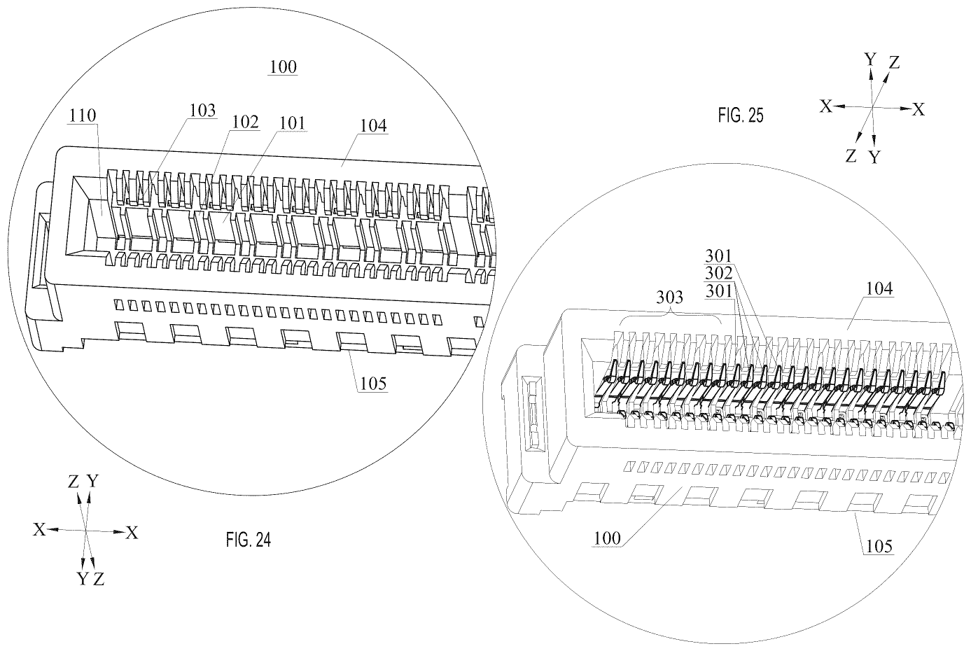

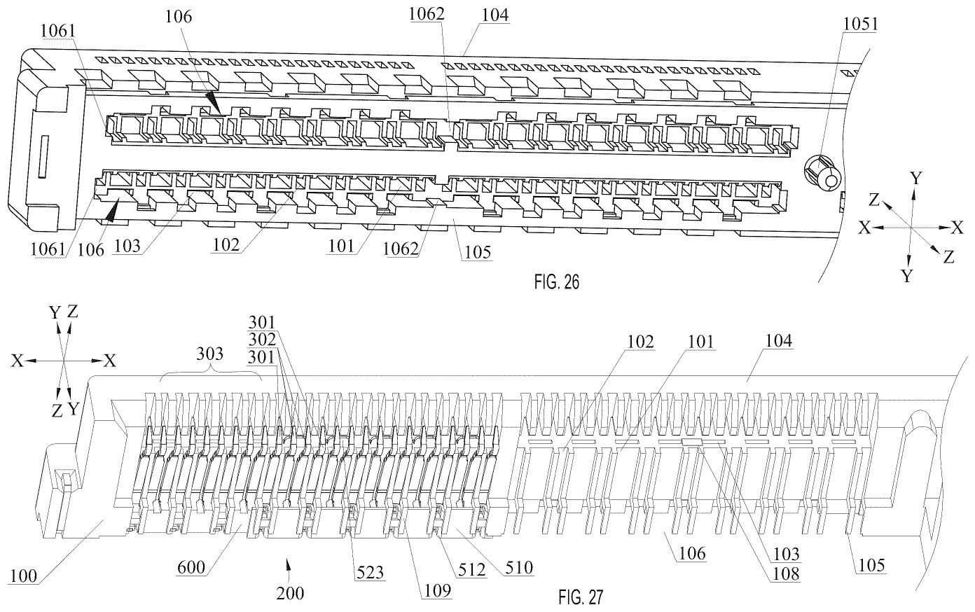

FIG. 24 is a top perspective view of a part of the housing 100, according to some embodiments, and FIG. 25 is added with the terminal assembly 200 relative to FIG. 24. FIG. 26 is a bottom perspective view of the part of the housing 100 shown in FIG. 24. For the purpose of clear and simply illustration, only one terminal assembly 200 is added in FIG. 27 relative to FIG. 26. As shown in the figures, besides the receiving grooves 103 for accommodating the first extensions 5230 of the outer shield 520, the housing 100 may further include a plurality of first grooves 101 and a plurality of second grooves 102. The plurality of first grooves 101 and the plurality of second grooves 102 are arranged in a row parallel to the longitudinal direction X-X. The plurality of first grooves 101 and the plurality of second grooves 102 are in communication with the slot 110. Exemplarily, the plurality of first grooves 101 and the plurality of second grooves 102 may be recessed from a side wall of the slot 110. The terminal assembly 200 includes a plurality of terminals 300 disposed in the row formed by the plurality of first grooves 101 and the plurality of second grooves 102. The plurality of terminals 300 may include a plurality of first terminals 302 extending into the plurality of first grooves 101 and a plurality of second terminals 301 extending into the plurality of second grooves 102. The plurality of first terminals 302 are arranged in pairs dispersed among the plurality of second terminals 301. The plurality of first grooves 101 are dispersed among the plurality of second grooves 102. The mating ends 310 of the first terminals 302 and the second terminals 301 are respectively bent from the first grooves 101 and the second grooves 102 into the slot 110.

The receiving grooves 103 may be spaced apart from the first grooves 101 along the transverse direction Y-Y. The first extensions 5230 of the shielding subassembly (such as the outer shield 520) are inserted into the receiving grooves 103. The receiving grooves 103 may position the first extensions 5230 and separate the first extensions 5230 from the first terminals 302, so as to prevent the first extensions 5230 from contacting the first terminals 302. The second terminals 301 may be grounded as shielding terminals. The shielding subassembly is in electrical contact with the second terminals 301, forming shielding protection for the first terminals 302.

Exemplarily, each pair of the first terminals 302 may be inserted into a corresponding first groove 101. The first groove 101 may have a dimension greater than that of the second groove 102 along the longitudinal direction X-X, so that each pair of the first terminals 302 may be accommodated in a single first groove 101. The second terminals 301 are accommodated in the second grooves 102, respectively. In some embodiments, the first terminals 302 are usually configured to transmit differential signals. The spacing between the first terminals 302 in a pair can be reduced without changing the overall size of the electrical connector, and/or the width of each first terminal 302 in the pair may be increased locally or globally to improve the signal integrity, by disposing in a single first groove 101.

Exemplarily, the housing 100 has a mating face 104 and a mounting face 105 opposite along the mating direction Z-Z. The slot 110 is recessed inward from the mating face 104, and the slot 110 is used to receive the second electrical component 920. A positioning post 1051 protrude from the mounting face 105 of the housing 100 may be inserted into a positioning hole of the first electrical component 910 to fix the electrical connector 10 in the horizontal direction. The housing 100 may also be fixed to the first electrical component 910 by a board lock 107, as shown in FIG. 3. The housing 100 may also include a mounting groove 106 recessed inward from the mounting face 105, as shown in FIGS. 26-27. The terminal assembly 200 including the assembly housing 600 and the shielding subassembly may be mounted in the mounting groove 106. After the shielding subassembly is attached to the assembly housing 600, the assembly housing 600, the terminals 300 and the shielding subassembly may be jointly mounted in the mounting groove 106. The side walls of the mounting groove 106 opposite along the transverse direction Y-Y may clamp the assembly housing 600 and the shielding subassembly, so that they may be firmly mounted in the housing 100. This may simplify the assembling of the electrical connector 10, and the assembly housing 600 may prevent the terminals 300 from being skewed during the assembling of the terminal assembly 200 into the housing 100. The assembly housing 600 may be fixed in the mounting groove 106 by any suitable means, such as interference fit, a snap, and/or an adhesive.

Exemplarily, the plurality of first grooves 101, the plurality of second grooves 102 and the receiving grooves 103 extend from the mounting groove 106 towards the mating face 104. The plurality of first grooves 101 and the plurality of second grooves 102 are recessed from side walls of the slot 110. The mating ends 310 of the plurality of first terminals 302 and the plurality of second terminals 301 are respectively bent from the plurality of first grooves 101 and the plurality of second grooves 102 into the slot 110. In this way, ribs may be formed between the first grooves 101 and the second grooves 102 to separate the first terminals 302 and the second terminals 301. Exemplarily, the first grooves 101 and the second grooves 102 may extend from the side walls of the slot 110 to the bottom wall of the slot 110, so that the first grooves 101 and the second grooves 102 may be in an L shape. The bottoms of the first grooves 101 and the second grooves 102 may have a wider width in the transverse direction Y-Y, and be completely communicated with the mounting groove 106. The bent mating ends 310 of the terminals 300 have a relatively large dimension along the transverse direction Y-Y. During the insertion of the terminal assembly 200 into the mounting groove 106 from the mounting face 105 of the housing 100, the wider bottoms of the first grooves 101 and the second grooves 102 allow the mating ends 310 to pass through, and the mating ends 310 can be configured to be bent into the slot 110.

Exemplarily, as shown in FIGS. 6 and 7, the plurality of first extensions 523 (e.g., each first extension 5230) may have a first surface 5233 facing a corresponding terminal 300 and a second surface 5234 opposite to the first surface 5233 along the transverse direction Y-Y. The dimension of the plurality of first extensions 523 may be smaller than that of the one or more receiving grooves 103 in the transverse direction Y-Y, and the root of the plurality of first extensions 523 may be bent towards the corresponding terminal 300, so that the first surface 5233 abuts against a side wall of the one or more receiving grooves 103 and the second surface 5234 is spaced apart from an opposed side wall of the one or more receiving grooves 103. The plurality of first extensions 523 may be elastic. The plurality of first extensions 523 smaller than the one or more receiving grooves 103 may reduce the friction force during the inserting of the plurality of first extensions 523 into the one or more receiving grooves 103. The first surface 5233 of the plurality of first extensions 523 abuts against the side wall of the one or more receiving grooves 103, such that the plurality of first extensions 523 can be closer to the first terminals 302. The shielding performance can be improved. Exemplarily, a chamfer may be provided at the lower part (at the opening of the one or more receiving grooves 103) of the side wall of the one or more receiving grooves 103 against which the first surface 5233 abuts.

In some embodiments, the inner shield 510 may be disposed below the slot 110, and the inner shield 510 extends beyond the mounting face 105. In this way, the inner shield 510 may provide shielding for the intermediate portions 320 of the first terminals 302 below the slot 110.

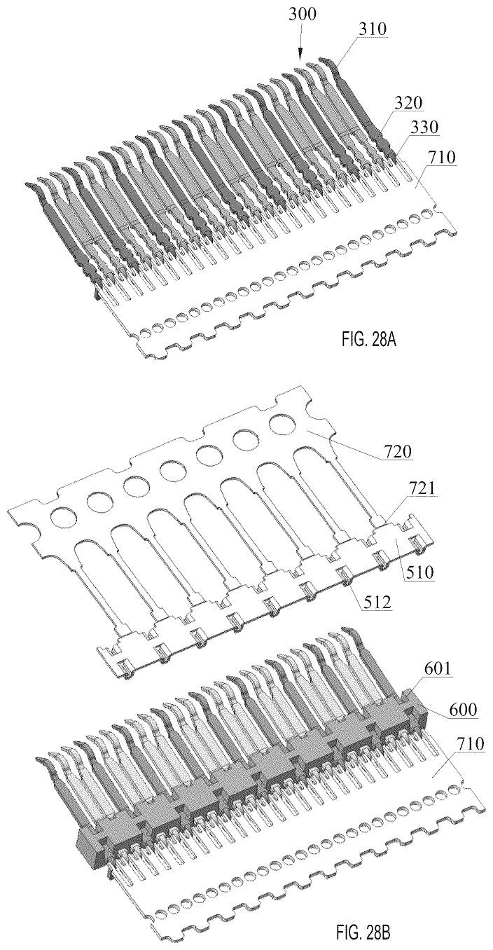

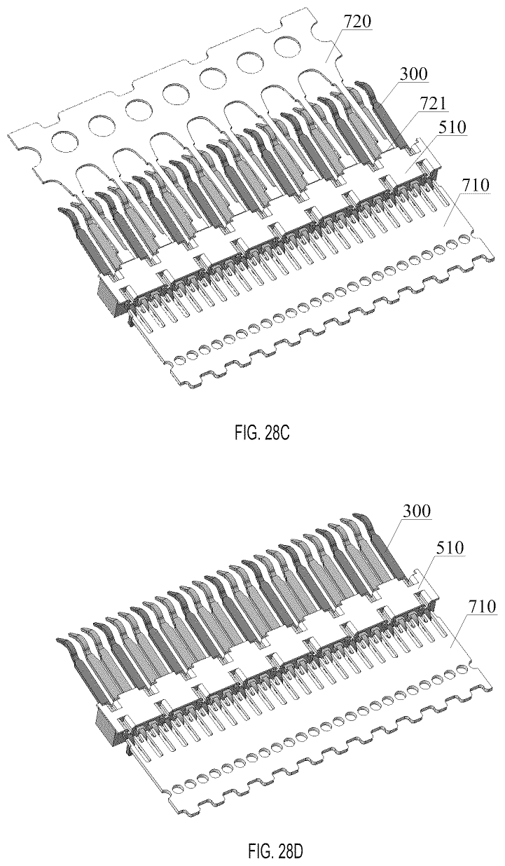

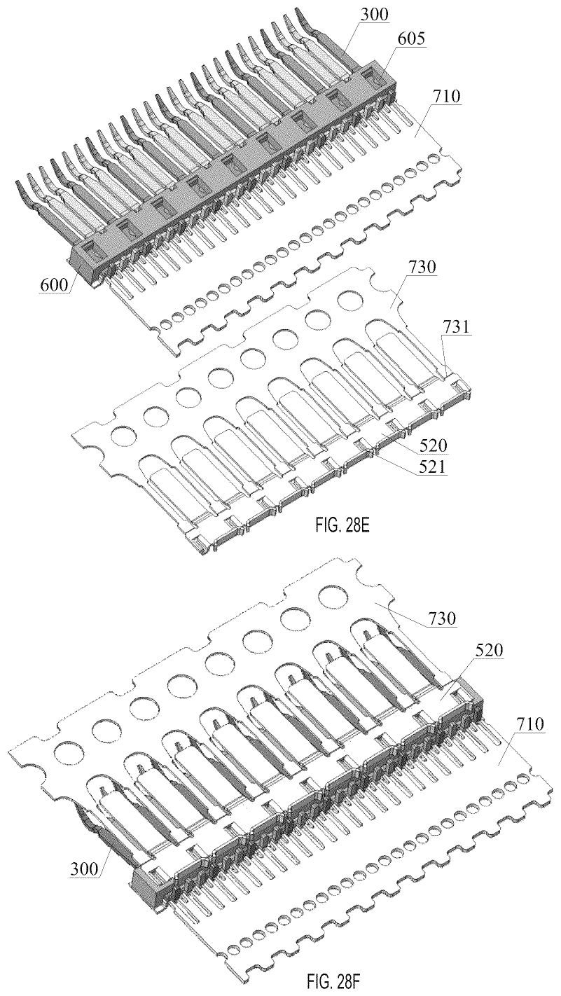

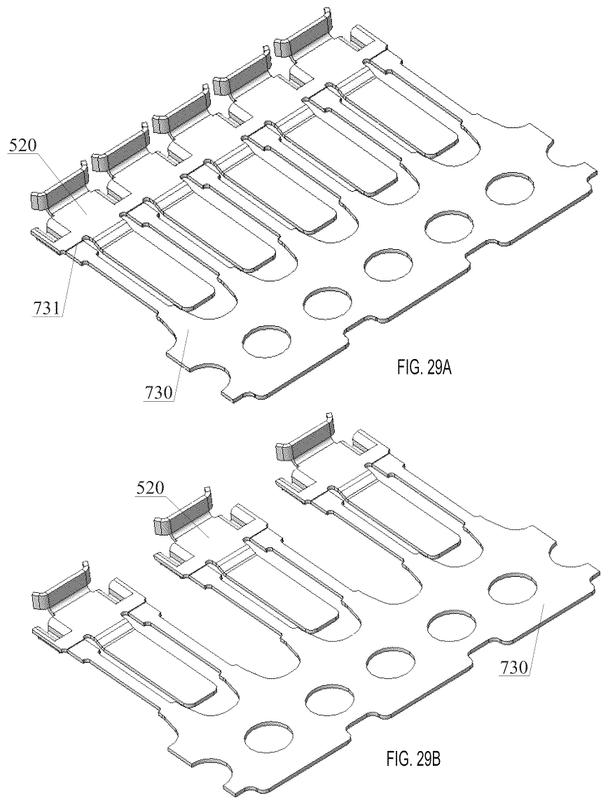

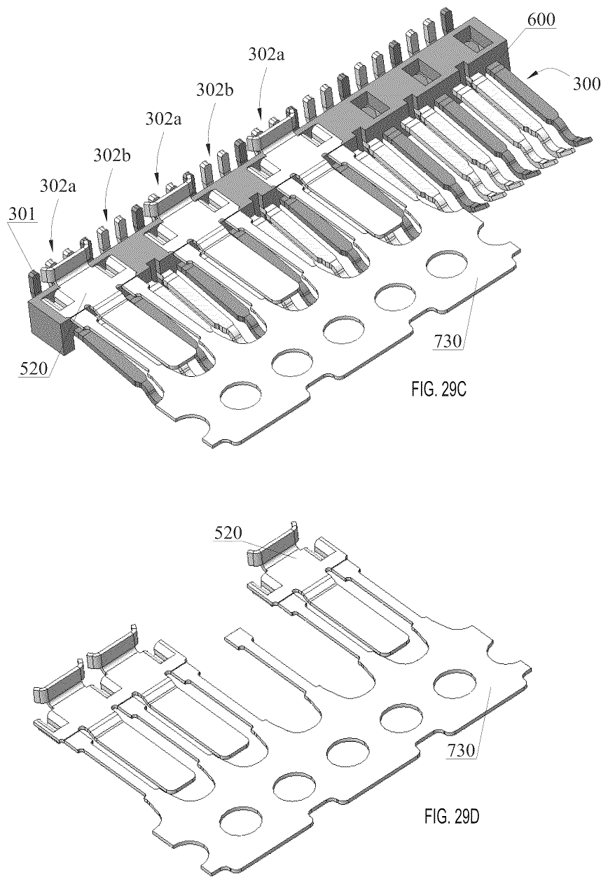

FIGS. 28A to 28F are perspective views illustrating manufacturing the terminal assembly 200, according to some embodiments. As shown in FIG. 28A, a plurality of independent terminals 300 are held by a leadframe 710. The plurality of terminals 300 may be arranged at intervals required for their installation on the housing 100 of the electrical connector 10. Exemplarily, the contact tails 330 of the plurality of terminals 300 may be held by the leadframe 710. Then, the assembly housing 600 is formed on the intermediate portions 320 of the plurality of terminals 300 by insert-molding, as shown in FIG. 28B. The plurality of opening groups (comprising the first openings 601 and the second openings 605) are formed in the assembly housing 600 corresponding to the plurality of second terminals during the insert-molding. An inner shielding frame 720 is provided, which is connected to the inner shield 510 with a plurality of groups of first protrusions 512. The inner shielding frame 720 may be connected to the inner shield 510 by first tie bars 721, which facilitate the inner shielding frame 720 to be separated from the inner shield 510. The inner shield 510 is attached to the assembly housing 600 with the first protrusions 512 of the inner shield 510 aligned with the first openings 601 of the assembly housing 600, as shown in FIG. 28C. Then, the inner shielding frame 720 may be bent upward to separate from the inner shield 510 at the first tie bars 721, as shown in FIG. 28D.

Then, the side of the assembly housing 600 having the second openings 605 is turned upward, as shown in FIG. 28E. An outer shielding frame 730 is connected to the outer shield 520 with a plurality of groups of second protrusions 522 by second tie bars 731. The second tic bars 731 facilitate the outer shielding frame 730 to be separated from the outer shield 520. As shown in FIG. 28F, the outer shield 520 is attached to the assembly housing 600 with the second protrusions 522 of the outer shield 520 aligned with the second openings 605 of the assembly housing 600. Then, the outer shielding frame 730 may be bent upward to separate from the outer shield 520 at the second tie bars 731.

It should be noted that the leadframe 710 may also be used to fix the semi-finished product by holding the plurality of terminals 300, when the operations are performed shown in FIGS. 28B to 28F. Optionally, the step shown in FIG. 28E may be omitted, and it is not necessary to turn the assembly housing 600 and the plurality of terminals 300. It is also possible to attach the outer shield 520 connected to the outer shielding frame 730 to the assembly housing 600 from below. In some embodiments, the first protrusions 512 of the inner shield 510 and/or the second protrusions 522 of the outer shield 520 may be welded to the second terminals, respectively. A first welding process for the first protrusions 512 may be performed in any step after the first protrusions 512 are inserted into the first openings 601. Similarly, a second welding process for the second protrusions 522 may be performed in any step after the second protrusions 522 are inserted into the second openings 605. Optionally, the first welding process and the second welding process may be performed simultaneously after both the first protrusions 512 and the second protrusions 522 are inserted in place. Exemplarily, the first welding process may be performed before the inner shielding frame 720 is separated from the inner shield 510, such that the inner shield 510 can be kept at its desired position. Similarly, the second welding process may be performed before the outer shielding frame 730 is separated from the outer shield 520, such that the outer shield 520 can be kept at its desired position.

Exemplarily, referring back to FIGS. 10 to 11, the plurality of terminals 300 included in each terminal assembly 200 may also include additional terminals 303. The shielding subassembly only spans the plurality of first terminals 302 and the plurality of second terminals 301 along the longitudinal direction. No shielding subassembly is provided on the sides of the additional terminals 303. The plurality of additional terminals 303 may be disposed on the periphery of the first terminals 302 and the plurality of second terminals 301. The additional terminals 303 may be used to transmit power and/or low-speed signals. In some embodiments, the additional terminals 303 may include side band terminals. The side band terminals may transmit low-frequency signals (e.g., with a frequency of less than 500 MHZ) and signals with lower data rates (e.g., less than 100 Mb/s). In some embodiments, the additional terminals 303 may also include power terminals. The power terminals may transmit direct current. Additionally or alternatively, the power terminals may transmit other high-current and/or low-frequency signals.

The additional terminals 303 may expand the performance of the electrical connector 10. The shielding subassembly only spanning the plurality of first terminals 302 and the plurality of second terminals 301 along the longitudinal direction X-X may simplify the design, reduce the influence on the additional terminals 303, and improve the performance.

Exemplarily, the locations of the additional terminals 303 are configurable relative to the first terminals 302 and the second terminals 301 in the longitudinal direction X-X. In an embodiment, the locations of the additional terminals 303 may be physically changed relative to the first terminals 302 and the second terminals 301. Further, the housing 100 may be configured such that even if the locations of the additional terminals 303 are physically changed, the terminals 300 may be installed in the adjusted locations. Optionally, the locations of the terminals 300 on the assembly housing 600 may be changeable, thereby changing the relative locations of the additional terminals 303. In another embodiment, after the terminals 300 are held on the assembly housing 600, the locations of the terminals may no longer be physically changed. Instead, the relative locations of the additional terminals 303 are changed by altering the location of the shielding subassembly. The terminals shielded by the shielding subassembly may serve as first terminals 301 to transmit high-speed signals, the terminals in electrical contact with the shielding subassembly may serve as second terminals for shielding the high-speed signals, and other unshielded terminals may serve as additional terminals for transmitting low-speed signals and/or power signals.

The additional terminals 303 may have various locations relative to the first terminals 302 and the second terminals 301. In the illustrated embodiment, the assembly housing 600 may be non-physically divided into two sections, namely a first section and a second section, in the longitudinal direction X-X. The first terminals 302 and the second terminals 301 are held on the first section, and the additional terminals 303 may be held on the second section. The second terminals 301 are arranged at intervals on the first section, and the first terminals 302 are dispersed among the second terminals 301 in pairs. Optionally, the first section may be divided into a plurality of first subsections, which are placed on two sides of the second section. Or optionally, the second section may be divided into a plurality of second subsections, which are placed on two sides of the first section. This may be suitable for various types of second electrical components 920 and first electrical components 910.

Exemplarily, the additional terminals 303 may include a plurality of additional first terminals 302 and a plurality of additional second terminals 301. first terminals 302 and second terminals 301 are repeatedly arranged according to a predetermined pattern. Exemplarily, any two adjacent pairs of first terminals 302 are separated by a second terminal 301, and any pair of first terminals 302 is disposed between two adjacent second terminals 301. The signal integrity can be improved. Two adjacent pairs of first terminals 302 share one second terminal 301, which may effectively reduce the number of second terminals 301. The density of signal terminals can be increased.

Referring to FIGS. 15 and 16, the terminal pairs S_1, S_2, S_3, S_4, S_5, S_6, S_7, and S_8 are formed by the first terminals 302, and the terminals G between these terminal pairs are second terminals. Referring to FIGS. 8 to 11 in combination, the inner shield 510 and/or the outer shield 520 are disposed on the sides of the terminal pairs S_4, S_5, S_6, S_7, S_8 and the terminals G around the terminal pairs S_4, S_5, S_6, S_7, S_8. The inner shield 510 and/or the outer shield 520 are connected to these terminals G, which may provide shielding for the terminal pairs S_4, S_5, S_6, S_7, and S_8. While no shield is provided on the sides of the remaining terminal pairs S_1, S_2, S_3 and the terminals G around the terminal pairs S_1, S_2, S_3, which are insulative from each other. Each of the terminal pairs S_1, S_2, S_3 and the terminals G around the terminal pairs S_1, S_2, S_3 may be used as an additional terminal for transmitting power and/or low-speed signals. Although it is not necessary to provide shielding for the additional terminals or the structural requirements for each additional terminal are not very strict based on the usage of the additional terminals, the additional terminals 303 are still desired to be composed of the first terminals 302 and the second terminals 301 which are repeatedly arranged in the same pattern as the first terminals 302 for transmitting high-speed signals and the second terminals 301 around them. Any one or more of the terminal pairs S_1, S_2, S_3, S_4, S_5, S_6, S_7, and S_8 may be used to transmit high-speed signals by changing the location of the shielding subassembly as desired, and the other terminal pairs may be used to transmit power and/or low-speed signals. Or, optionally, all the terminal pairs may be used to transmit high-speed signals without providing additional terminals. Referring back to FIG. 3, the electrical connector 10 may include ten terminal assemblies 200, and the number of terminals 300 included in these terminal assemblies 200 may be the same or different. Exemplarily, the first terminals 302 and the second terminals 301 may be repeatedly arranged in the predetermined pattern in each terminal assembly 200. The locations of the shielding assemblies of these terminal assemblies 200 and the lengths of the shielding subassemblies may be configurable along the longitudinal direction X-X as needed. Target terminal pairs in each terminal assembly 200 may transmit high-speed signals by configuring the locations and lengths of the shielding subassembly, and the other terminal pairs and the terminals G around them may serve as the additional terminals 303. In some embodiments, the shielding subassembly may include the inner shield 510 and/or the outer shield 520 in each terminal assembly 200.

In order for the locations and lengths of the shielding subassembly to be efficiently configurable as needed, the assembly housing 600 may also include a plurality of additional opening groups, which expose the plurality of additional second terminals, respectively. As shown in FIGS. 8 to 11 and FIGS. 15 to 16, the shielding subassembly may include the inner shield 510. Each of the groups of additional openings may include a first opening 605′. The location and/or length of the inner shield 510 on the assembly housing 600 is configurable to electrically contact with corresponding second terminals 301 via target first openings. The target first openings may include at least a part of the first opening 605 and the first opening 605′. The first protrusions 512 on the inner shield 510 may make electrical contact with the corresponding second terminal 301 via the target first openings. In this way, the first terminals 302 among the corresponding second terminals 301 may be used to transmit high-speed signals. The other first terminals 302 and second terminals 301 may serve as the additional terminals 303. In this way, the locations of the additional terminals 303 are configurable.

Optionally, the shielding subassembly may include the outer shield 520. Each of the additional opening groups may include a second opening 605′. The location and/or length of the outer shield 520 on the assembly housing 600 is configurable to electrically contact with corresponding second terminal 301 via target second opening. The target second opening may include at least a part of the second opening 605 and the second opening 605′. The second protrusions 522 on the outer shield 520 may make electrical contact with the corresponding second terminal 301 via the target second openings. In this way, the first terminals 302 among the corresponding second terminals 301 may be used to transmit high-speed signals. The other first terminals 302 and second terminals 301 may serve as the additional terminals 303. In this way, the locations of the additional terminals 303 are configurable.

The inner shield 510 and the outer shield 520 may make electrical contact with the same second terminals 301 to form a good shielding for the first terminals 302 among the second terminals 301. It may be understood that the present application does not exclude the embodiments where the inner shield 510 and the outer shield 520 make electrical contact with different second terminals 301. For example, there are some second terminals 301 electrically contacting both the inner shield 510 and the outer shield 520, some second terminals 301 only electrically contacting the inner shield 510, and some second terminals 301 only electrically contacting the outer shield 520; or second terminals 301 electrically contacting the inner shield 510 are completely different from second terminals 301 electrically contacting the outer shield 520.

In order for the locations of the shielding subassembly to be efficiently configurable, the pitches between the terminals 300 of each terminal assembly 200 may be equal. In other words, the additional terminals 303 may have no difference in structure and arrangement from the other terminals 300. Among the terminals 300 with shielding subassembly on the sides thereof, the second terminals 301 may make electrical contact with the shielding subassembly, and the first terminals 302 may be used to transmit high-speed signals. The other terminals 300 without the shielding subassembly may be used as the additional terminals 303. For an electrical connector 10 that requires more additional terminals 303, the shielding subassembly may be appropriately shortened, such that the second terminals 301 connected to the shielding subassembly are reduced. In this way, more second terminals 301 may be used to transmit power or low-speed signals. For an electrical connector 10 that requires more first terminals 302 for transmitting high-speed signals, the shielding subassembly may be appropriately lengthened. The longest length may be substantially the same as that of the assembly housing 600 in the longitudinal direction X-X. In this way, more first terminals 302 may be shielded, and the terminals available for transmitting high-speed signals may be increased. The length of the shielding subassembly is configurable as needed, without changing the parameters of other components. The compatibility can be better and the costs are lower.

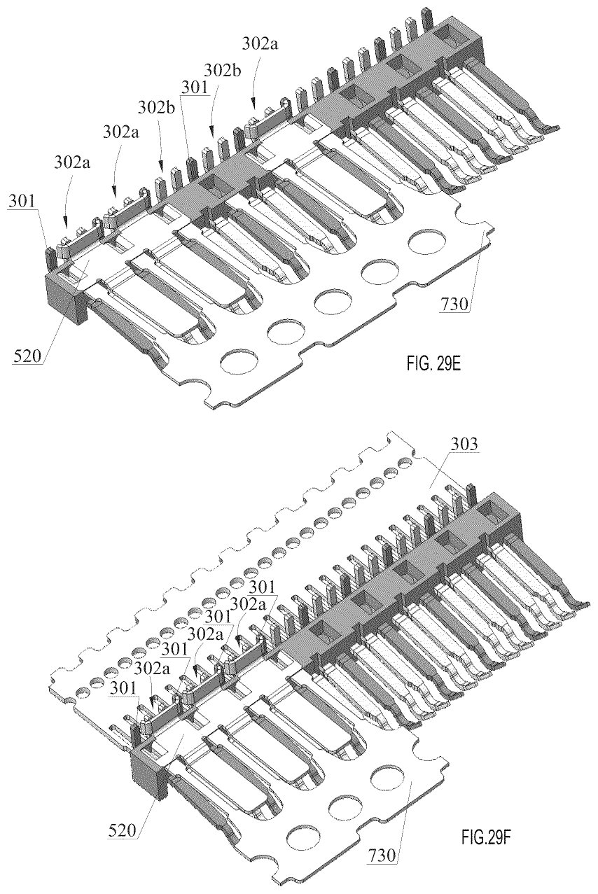

In case that the pitches between the terminals 300 are equal, optionally, each of the additional opening groups may be the same as any of the opening groups in structure, and all groups are arranged at equal intervals along the longitudinal direction X-X. In this way, the inner shield 510 and the outer shield 520 each may include repeating units corresponding to the terminal pairs of first terminals 302. When the terminal assembly 200 is manufactured as shown in FIGS. 28A to 28F, the inner shielding frame 720 connected to the inner shield 510 and the outer shielding frame 730 connected to the outer shield 520 may include repeating units, respectively. In this way, according to the number and relative locations of the terminal pairs of the first terminals 302 to be shielded, an appropriate number of units may be selected. As shown in FIGS. 29A to 29C, there are first terminal pairs 302a to be shielded and second terminal pairs 302b among the first terminal pairs 302a. The second terminal pairs 302b may serve as the additional terminals that do not need to be shielded. The outer shield 520 including n repeating units may be provided, where n is the total number of the first terminal pairs 302a and the second terminal pairs 302b. Then, as shown in FIG. 29B, some units of the outer shield 520 corresponding to the second terminal pairs 302b are removed. Other units of the outer shield 520 are kept together by the outer shielding frame 730 as shown in FIG. 29B, and installed onto the assembly housing 600 with the terminals 300. Finally, the outer shielding frame 730 is removed along the second tie bar 731 to form the terminal assembly 200. In this way, the assembly efficiency can be improved.

Optionally, when it is desired to have more, such as two, second terminal pairs 302b between two first terminal pairs 302a, more units of the outer shield 520 may be removed from the outer shielding frame 730, as shown in FIGS. 29D to 29E. The other units of the outer shield 520 are installed onto the assembly housing 600 by using the outer shielding frame 730. Since the second terminal 301 between the two second terminal pairs 302b is not electrically connected to the outer shield 520, this second terminal 301 may also be used to transmit low-speed signals and/or power signals.

Optionally, when only the second terminals 301 are provided between the first terminal pairs 302a to be shielded, there is no need to process the outer shield 520 on the outer shielding frame 730. When the number of the first terminal pairs 302a is m, the outer shielding frame 730 connected with the outer shield 520 including m repeating units may be provided. In this case, since two adjacent first terminal pairs 302a may share one second terminal 301, the second terminals 301 among these first terminals 302 may be reduced, and therefore the additional terminals 303 can be increased.

In the embodiments shown in FIG. 29E, each first terminal pair 302a is between adjacent second terminals 301. The second terminal pairs 302b used as the additional terminals may also be between adjacent second terminals 301. In this case, at least an additional second terminal 301 is needed to separate the second terminal pairs 302b from the first terminal pairs 302a. In contrast, as shown in FIG. 29F, only second terminals 301 are placed among the first terminal pairs 302a. Since every two adjacent pairs of first terminal pairs 302a may share a second terminal 301 therebetween, the second terminals 301 may be reduced, and the transmission density of signals may be improved.

Since the locations and lengths of the inner shield 510 and the outer shield 520 are configurable, a portion of the terminal assembly 200 with no shielding subassembly, such as right portions shown in FIGS. 29C and 29E, may be thinner, the thickness of which is only determined by the assembly housing 600. However, the mounting groove 106 in the housing 100 has consistent width along its length direction (the longitudinal direction X-X), so that the housing 100 may be standardized. Although the right portions of the terminal assembly 200 are thinner in FIGS. 29C and 29E, the left portion of the terminal assembly 200 may also be thinner in other embodiments not shown. In order to prevent the thinner portion from shaking in the wider mounting groove 106, exemplarily, referring back to FIG. 26, the mounting groove 106 has a first groove end 1061 and a second groove end 1062 opposite along the longitudinal direction X-X. The widths of the first groove end 1061 and the second groove end 1062 may be smaller than the width of the mounting groove 106, so as to position the thinner ends of the terminal assembly 200 respectively. If a shielding subassembly needs to stretch to a distal end of the terminal assembly 200, the thinner ends of the assembly housing 600 may protrude beyond the shielding subassembly along the longitudinal direction X-X. In this way, the thinner ends of the shielding subassembly may be inserted into the first groove end 1061 and the second groove end 1062 respectively.

According to another aspect of the present application, an electronic system is provided. The electronic system may include a second electrical component 920, such as an add-in card. The add-in card may have a ground layer 922 inside. Referring back to FIG. 7, the surface of the add-in card has contact pads 921. The electronic system may also include an electrical connector 10, which may include a slot 110, a plurality of terminals 300 and a shielding subassembly. The slot 110 extends along the longitudinal direction X-X. The plurality of terminals 300 are arranged in a row parallel to the longitudinal direction X-X on the side of the slot 110. The add- in card is inserted into the slot 110. The contact pads 921 on the add-in card may make electrical contact with the terminals 300. The shielding subassembly may include an inner shield 510 and an outer shield 520. The inner shield 510 and the outer shield 520 are disposed on two sides of the terminals 300 opposite along the transverse direction Y-Y respectively. The ground layer 922 and the inner shield 510 form inner shielding for the terminals 300, and the outer shield 520 forms outer shielding for the terminals 300. A better shielding protection may be provided for the terminals 300, which are suitable for the transmission of high-density and high-speed signals. The electronic system is smaller and simpler.

Having thus described several aspects of several embodiments of electrical connectors and systems, it is to be appreciated that various alterations, modifications, and improvements will readily occur to those skilled in the art. Such alterations, modifications, and improvements are intended to be part of this disclosure, and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

For example, the electrical connectors described above may be card edge connectors, backplane connectors, daughter card connectors, etc.

As another example, although many inventive aspects have been described with reference to vertical connectors as mentioned above, it should be understood that the aspects of the present disclosure are not limited to this. That is to say, any of the inventive features, whether alone or in combination with one or more other inventive features, can also be applied to other types of connectors, such as right-angle connectors and coplanar connectors, etc.

While various inventive embodiments have been described and illustrated, those of ordinary skill in the art will readily envision a variety of other means and/or structures for performing the function and/or obtaining the results and/or one or more of the advantages described, and each of such variations and/or modifications is deemed to be within the scope of the inventive embodiments described. More generally, those skilled in the art will readily appreciate that all parameters, dimensions, materials, and configurations described are meant to be examples and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure may be directed to each individual feature, system, system upgrade, and/or method described. In addition, any combination of two or more such features, systems, and/or methods, if such features, systems, system upgrade, and/or methods are not mutually inconsistent, is included within the inventive scope of the present disclosure.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

In the description of the present disclosure, it is to be understood that orientation or positional relationships indicated by orientation words “front”, “rear”, “upper”, “lower”, “left”, “right”, “transverse direction”, “mating direction”, “perpendicular direction”, “perpendicular”, “horizontal”, “top”, “bottom” and the like usually are shown based on the accompanying drawings, only for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” may encompass both the orientations of “above” and “below”. In addition, these components or features may be otherwise oriented (for example rotated by 90 degrees or other angles) and the present disclosure is intended to include all these cases.

It should be noted that the terms used herein are only for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

It should be noted that the terms “first”, “second” and the like in the description and claims, as well as the above accompanying drawings, of the present disclosure are used to distinguish similar objects, but not necessarily used to describe a specific order or precedence order. It should be understood that ordinal numbers used in this way may be interchanged as appropriate, so that the embodiments of the present disclosure described herein may be implemented in a sequence other than those illustrated or described herein.

What is claimed is:

1. A terminal assembly, comprising:
a plurality of terminals, each of the plurality of terminals comprising a mating end, a contact tail, and an intermediate portion between the mating end and the contact tail;
a housing at least partially holding the intermediate portions of the plurality of terminals such that the plurality of terminals are aligned in a row, the housing comprising a plurality of openings exposing selected terminals of the plurality of terminals; and
a shield comprising portions protruding into respective openings of the plurality of openings of the housing.

2. The terminal assembly of claim 1, wherein:
the shield spans one or more segments of the plurality of terminals aligned in the row.

3. The terminal assembly of claim 2, wherein:
the plurality of terminals comprise a plurality of pairs of terminals, each pair disposed between adjacent terminals of the selected terminals of the plurality of terminals.

4. The terminal assembly of claim 3, wherein:
for each segment of the one or more segments of the plurality of terminals spanned by the shield, the pairs of terminals are configured for high-speed signal transmission, and the selected terminals are configured for ground; and
terminals that are outside the shield are configured for side band.

5. The terminal assembly of claim 1, wherein:
the shield protrudes beyond the housing towards the contact tails of the plurality of terminals.

6. The terminal assembly of claim 3, wherein:
the shield comprises a body and one or more extensions, each of the one or more extensions extending from the body towards the mating ends of a respective pair of terminals.

7. The terminal assembly of claim 6, wherein:
the shield comprises one or more second extensions, each of the one or more second extensions extending from the body and transversely to the body greater than 65 degrees with respect to the body to overlap the contact tails of a respective pair of terminals, the contact tails of the respective pair of terminals configured for surface mounting.

8. The terminal assembly of claim 7, wherein:
each of the one or more second extensions comprises one or more beams extending towards the contact tails of terminals adjacent a respective pair of terminals.

9. The terminal assembly of claim 1, wherein:
the shield is a first shield attached to a first side of the housing;
the plurality of openings exposing the selected terminals of the plurality of terminals are a plurality of first openings exposing the selected terminals of the plurality of terminals from the first side of the housing;
the housing comprises a plurality of second openings exposing the selected terminals of the plurality of terminals from a second side of the housing, the second side opposite the first side; and
the terminal assembly comprises a second shield attached to the second side of the housing, the second shield comprising portions protruding into respective openings of the plurality of second openings of the housing.

10. The terminal assembly of claim 1, wherein:
the plurality of terminals are disposed in a pitch ranging from 0.60 mm to 0.70 mm.

11. An electrical connector, comprising:
a housing comprising a plurality of first grooves and a plurality of second grooves disposed alternatively in a row; and
a terminal assembly comprising:
a plurality of terminals comprising a plurality of pairs of terminals extending in the plurality of first grooves, and a plurality of single terminals extending in the plurality of second grooves,
a subassembly housing, and
a shield electrically contacting the plurality of single terminals.

12. The electrical connector of claim 11, wherein:
the housing comprises a mating face, a mounting face, and a slot recessed from the mating face;
the terminal assembly is disposed on a side of the slot, each of the plurality of terminals comprising a mating end curving into the slot, a contact tail extending beyond the mounting face, and an intermediate portion between the mating end and the contact tail; and
the shield is L-shaped so as to have a plurality of extensions parallel to the plurality of pairs of terminals and a plurality of protrusions electrically coupled to the plurality of single terminals.

13. The electrical connector of claim 12, wherein:
the housing comprises one or more receiving grooves spaced apart from the plurality of first grooves and the plurality of second grooves; and
the shield extends in the one or more receiving grooves.

14. The electrical connector of claim 13, wherein, for each pair of the plurality of pairs of terminals:
the intermediate portions are disposed between the slot and a respective one of the one or more receiving grooves.

15. The electrical connector of claim 13, wherein:
the shield comprises a body; and
the plurality of extensions extending from the body into a respective one of the one or more receiving grooves and towards the mating face of the housing.

16. The electrical connector of claim 15, wherein:
the plurality of extensions are a plurality of first extensions extending from the body of the shield;
the shield comprises a plurality of second extensions extending from the body to outside the housing and disposed between the housing and the contact tails of the plurality of terminals.

17. The electrical connector of claim 15, wherein:
the shield is a first shield attached to a first side of the subassembly housing; and
the terminal assembly comprises a second shield attached to a second side of the subassembly housing and electrically contacting the plurality of single terminals.

18. The electrical connector of claim 17, wherein:
the second shield is disposed below the slot and extends beyond the mounting face; and
the first shield comprises a body and a plurality of extensions extending from the body and parallel to the contact tails of the plurality of pairs of terminals.

19. An electrical connector comprising:
a housing comprising a slot; and
a terminal subassembly disposed on a side of the slot of the housing, the terminal subassembly comprising:
a plurality of terminals disposed in a row;
a first shield separated from the slot of the housing by the plurality of terminals;
a second shield disposed below the slot of the housing; and
a subassembly housing comprising a plurality of openings through which the first and second shields can be attached to terminals configured for ground.

20. The electrical connector of claim 19, wherein:
the plurality of terminals comprises a plurality of pairs of first terminals and a plurality of second terminals disposed between adjacent pairs of first terminals; and
both the first shield and the second shield are in electrical contact with a selected portion of the plurality of second terminals.
